(19) United States
(12) Patent Application Publication
(10) Pub. No.: US 2007/0182740 A1
(43) Pub. Date: Aug. 9, 2007

(54) Information processing method, information processor, recording medium, and program

(76) Inventors: Shuichi Konami, Chiba (JP); Ken Miyashita, Tokyo (JP); Kouichi Matsuda, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/640,898

(22) Filed: Dec. 19, 2006

(30) Foreign Application Priority Data
Jan. 5, 2006 (JP) 2006-000646

(51) Int. Cl. G06T 11/20

(52) U.S. Cl. 345/440

(57) ABSTRACT

A method of processing information is disclosed. The method includes the steps of: creating a timeline based on data used in executing a user interface; creating a state transition diagram based on the data; manipulating the timeline or the state transition diagram; editing the timeline based on contents of the manipulation of the timeline performed in the manipulating step; editing the state transition diagram based on contents of the manipulation of the state transition diagram performed in the manipulating step; and editing and updating the data based on results of the edit of the timeline performed by processing performed in the step of editing the timeline or on results of the edit of the state transition diagram performed by processing performed in the step of editing the state transition diagram.

### CROSS REFERENCE TO RELATED APPLICATION

The present invention contains subject matter related to Japanese Patent Application JP2006-000646 filed in the Japanese Patent Office on Jan. 5, 2006, the entire contents of which being incorporated herein by reference.

### BACKGROUND OF THE INVENTION

1. Field of the Invention

The present invention relates to information processing method, information processor, recording medium, and program and, more particularly, to information processing method, information processor, recording medium, and program which permit a UI (User Interface) program to be edited irrespective of whether the format is a timeline diagram or a state transition diagram (STD) to thereby improve the efficiency of development.

2. Description of the Related Art

Generally, development tools for assisting development of application software programs are becoming widespread. For example, a tool for creating graphical user interfaces (GUIs), which display animations while switching them according to events, using timelines and event processing rules is proposed (see, for example, JP-A-2005-196669 (patent reference 1)).

In one type of GUIs developed using such tools, an animation is kept displayed while varying the animation, for example, according to the internal event without depending on user's manipulations. One example of the event is that the remaining charge in a battery becomes lower than a given amount. Another example is that the state in which user's manipulation is not performed persists for more than a given time.

### SUMMARY OF THE INVENTION

A timeline assumes a data hierarchy showing the time-sequenced order in which plural animations are reproduced. Therefore, where interactive processing in which jumps are repetitively carried out is represented, the user would need to be conscious of the whole configuration of the timeline typically at all times. It has been difficult to perspectively view the hierarchy of the whole operation of the UI (User Interface). Consequently, it has been difficult to understand the whole operation intuitively.

Furthermore, GUIs using timelines are not yet maturely developed. In addition, techniques regarding modeling, testing, and debugging have not yet been established. Therefore, it is difficult to manage the quality of created contents.

In view of the circumstances described so far, it is desirable to provide a technique which enables mutual conversion between a timeline and a state transition diagram by representing a program for executing the same graphical user interface (GUI) in terms of data expressed from different points of view, i.e., state transition diagram and timeline. Furthermore, it is desirable to provide a technique of developing the same graphical user interface (GUI) irrespective of which one of them is edited. As a result, the technique of developing GUIs using the existing state transition diagram (which may contain a state transition table) can be applied to development performed using a timeline.

A method of processing information in accordance with one embodiment of the present invention includes the steps of: (A) creating a timeline based on data used in executing a user interface; (B) creating a state transition diagram based on the data; (C) manipulating the timeline or the state transition diagram; (D) editing the timeline based on contents of the manipulation of the timeline performed in the step (C); (E) editing the state transition diagram based on contents of the manipulation of the state transition diagram performed in the step (C); and (F) editing and updating the data based on results of the edit of the timeline by processing performed in the step (D) or on results of the edit of the state transition diagram performed by processing performed in the step (E).

The data can contain rules of displaying animations, rules of processing events, and information about labels.

In the step (F) above for editing and updating the data, in a case where the corresponding rules of processing events are modified as a result of the edit of the timeline because of the processing performed in the step (D), or in a case where the corresponding rules of processing events are modified as a result of edit of the state transition diagram because of the processing performed in the step (E), if a factor causing generation of a state is produced, a new label of the same structure as the above-described labels can be added to the labels contained in the data, the resulting data can be edited, and an update can be made. A step (G) of editing and updating the rules of processing the events in the data can be added in a case (i) where the corresponding rules of processing events are modified as a result of edit of the timeline because of the processing performed in the step (D) or in a case (ii) where the corresponding rules of processing events are modified as a result of edit of the state transition diagram because of the processing performed in the step (E). A step (H) of creating new label information can be added when a factor producing the state has taken place in a case (iii) where the rules of processing events are edited and updated as a result of processing performed in the step (G) for editing and updating rules of processing events. A step (I) of editing and updating the rules of displaying animations regarding the data can be added in a (iv) case where the corresponding rules of displaying animations are modified as a result of the edit of the timeline because of the processing performed in the step (D) of editing the timeline or the corresponding rules of displaying animations are modified as a result of edit of the state transition diagram because of the processing performed in the step (E) of editing the state transition diagram. In the step of editing the data, the data can be edited and updated based on (a) the rules of processing events created by the processing in the step of setting rules of processing rules, (b) label information created by the processing in the step of setting labels, and (c) the rules of displaying animations created by the processing in the step of setting rules of displaying animations.

An information processor according to one embodiment of the present invention has: (A) timeline creation means for creating a timeline based on data used in executing a user interface; (B) state transition diagram creation means for creating a state transition diagram based on the data; (C) manipulation means for manipulating the timeline or the state transition diagram; (D) timeline editing means for editing the timeline based on contents of the manipulation of the timeline performed by the manipulation means; (E) state transition diagram (STD) editing means for editing the state transition diagram based on contents of the manipulation of the state transition diagram performed by the manipulation means; and (F) data editing means for editing and updating the data based on results of edit of the timeline performed by the timeline editing means or on results of edit of the state transition diagram performed by the STD editing means.

A program recorded in a recording medium in accordance with one embodiment of the present invention is adapted to implement a method including the steps of: (A) creating a timeline based on data used in executing a user interface; (B) creating a state transition diagram based on the data; (C) manipulating the timeline or the state transition diagram; (D) editing the timeline based on contents of the manipulation of the timeline performed in the step (C); (E) editing the state transition diagram based on contents of the manipulation of the state transition diagram performed in the step (C); and (F) editing and updating the data based on results of the edit of the timeline performed in the step (D) or on results of the edit of the state transition diagram performed by the processing in the step (E).

A program according to one embodiment of the present invention is adapted to cause a computer to execute the steps of: (A) creating a timeline based on data used in executing a user interface; (B) creating a state transition diagram based on the data; (C) manipulating the timeline or the state transition diagram; (D) editing the timeline based on contents of the manipulation of the timeline performed in the step (C); (E) editing the state transition diagram based on contents of the manipulation of the state transition diagram performed in the step (C); and (F) editing and updating the data based on results of the edit of the timeline performed in the step (D) or on results of the edit of the state transition diagram performed in the step (E).

In information processing method, information processor, and program according to embodiments of the present invention, a timeline is created based on data used in executing a user interface. A state transition diagram is created based on the data. The timeline or the state transition diagram is manipulated. The timeline is edited based on contents of the manipulation of the timeline. The state transition diagram is edited based on contents of the manipulation of the state transition diagram. The data is edited and updated based on results of the edit of the timeline or on results of the edit of the state transition diagram.

The information processor may be an independent apparatus or a block of an information processor that processes information.

As described so far, according to one embodiment of the invention, the efficiency of development of UI programs can be improved.

Furthermore, according to one embodiment of the invention, a timeline and a state transition diagram can be converted into each other based on the same UI program.

### BRIEF DESCRIPTION OF THE DRAWINGS

FIG. 1 is a diagram showing the configuration of one example of an editing device according to one embodiment of the present invention.

FIG. 2 is a diagram showing one example of configuration of a reproduction apparatus for reproducing UI configuration data edited by the editing device of FIG. 1.

FIG. 3 is a flowchart illustrating processing for reproducing UI configuration data performed by the reproduction apparatus of FIG. 2.

FIG. 4 is a diagram illustrating a state transition diagram and a timeline corresponding to UI configuration data.

FIG. 5 is a flowchart illustrating processing for editing a timeline by the editing device of FIG. 1.

FIG. 6 is a flowchart illustrating processing for displaying a timeline, the processing being contained in the processing of FIG. 5 for editing a timeline.

FIG. 7 is a diagram illustrating a state transition diagram and a timeline corresponding to UI configuration data.

FIG. 8 is another diagram illustrating a state transition diagram and a timeline corresponding to UI configuration data.

FIG. 9 is a flowchart illustrating processing for editing UI configuration data based on the manipulation for editing the timeline, the manipulation being contained in the processing of FIG. 5 to edit a timeline.

FIG. 10 is a flowchart illustrating the processing performed by the editing device of FIG. 1 to edit a state transition diagram.

FIG. 11 is a flowchart illustrating the processing for displaying a timeline, the processing being contained in the processing of FIG. 10 to edit a state transition diagram.

FIG. 12 is a flowchart illustrating editing processing of UI (user interface) configuration data based on manipulation for editing a state transition diagram, the manipulation being contained in the processing of FIG. 10 to edit a state transition diagram.

FIG. 13 is a diagram illustrating processing for editing UI configuration data based on manipulation for editing a state transition diagram, the manipulation being contained in the processing of FIG. 10 to edit a state transition diagram.

FIG. 14 is a diagram showing a state transition diagram and a timeline corresponding to UI configuration data.

FIG. 15 is another diagram showing a state transition diagram and a timeline corresponding to UI configuration data.

FIG. 16 is a diagram illustrating editing processing performed when the state length is modified by a timeline.

FIG. 17 is a diagram illustrating processing for editing state transitions by a timeline.

FIG. 18 is a view showing a recording medium.

### DESCRIPTION OF THE PREFERRED EMBODIMENTS

Embodiments of the present invention are hereinafter described. The relationship between each component constituting the present invention and each embodiment described in the detailed description of the present invention is described now. This description is intended to confirm that embodiments supporting the present invention are set forth in the detailed description of the invention. Accordingly, if there are embodiments which are described in the detailed description of the present invention but not described herein as those corresponding to constituent components of the present invention, it is not meant that those embodiments fail to correspond to the constituent components. Conversely, if there is any embodiment that is set forth herein as corresponding to the constituent components, it is not meant that this embodiment fails to correspond to constituent components other than those constituent components.

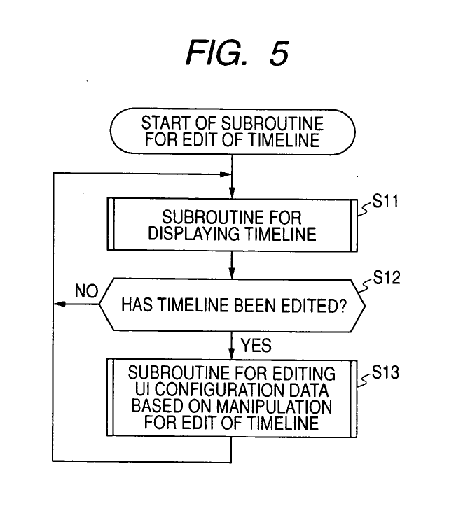

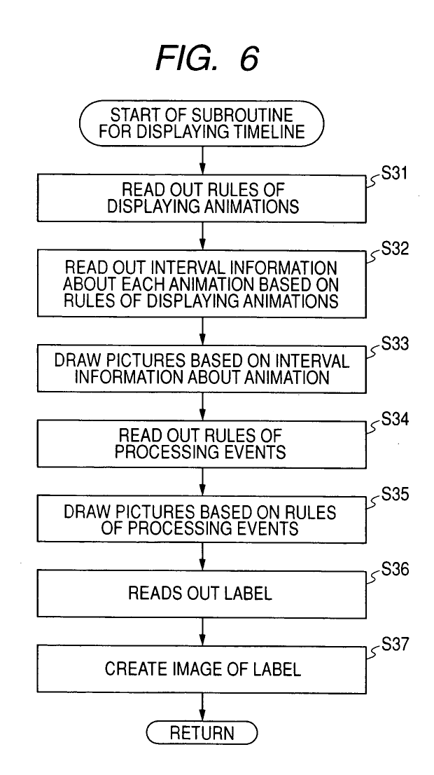

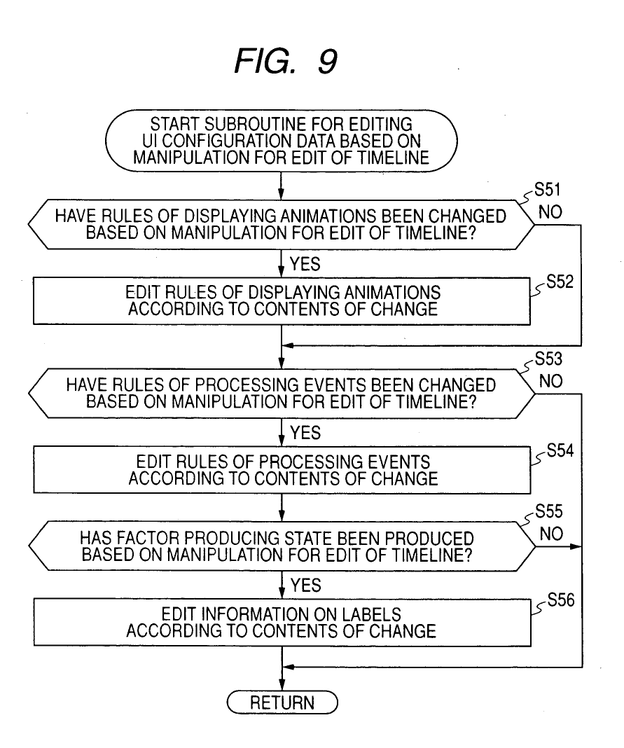

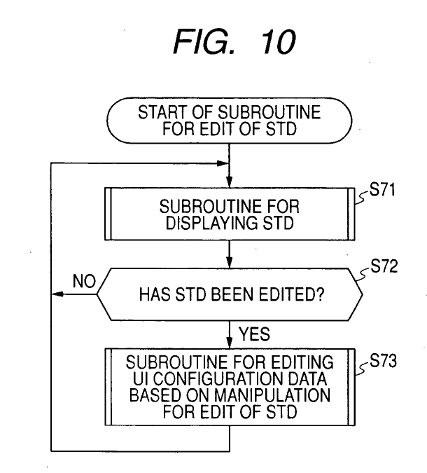

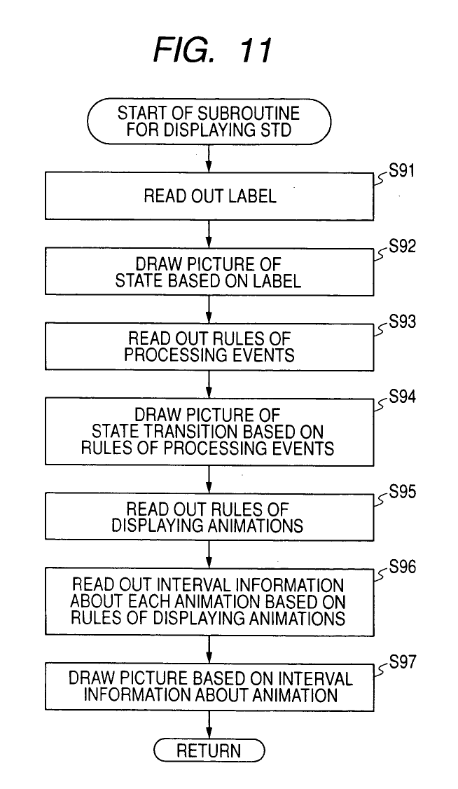

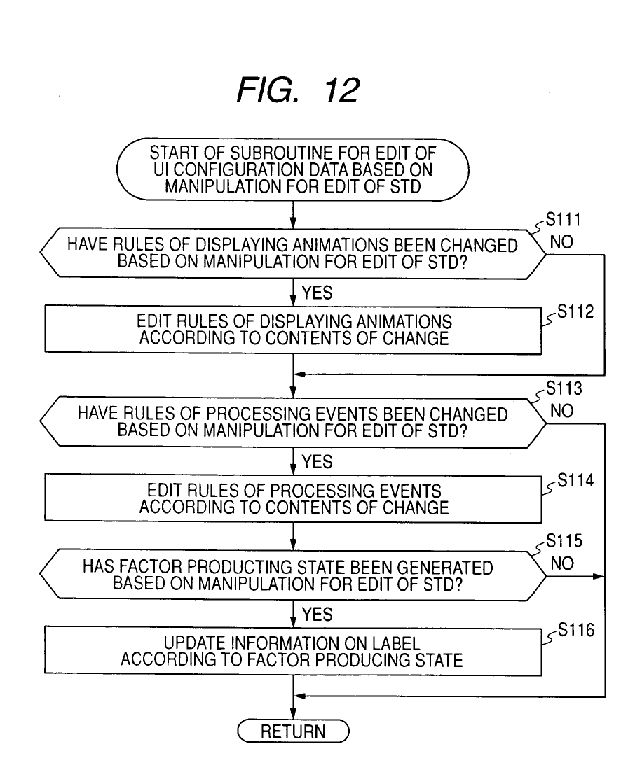

That is, information processing method and program according to embodiments of the present invention have the steps of: (A) creating a timeline based on data used in executing a user interface (for example, processing of steps S33, S35, and S37 in the flowchart of FIG. 6); (B) creating a state transition diagram based on the data (for example, processing of steps S92, S94, and S97 in the flowchart of FIG. 11); (C) manipulating the timeline or the state transition diagram (for example, processing of step S12 and S72 in the flowcharts of FIGS. 5 and 10, respectively); (D) editing the timeline based on contents of the manipulation of the timeline performed in the step (C) (for example, processing of steps S52, S54, and S56 in the flowchart of FIG. 9); (E) editing the state transition diagram based on contents of the manipulation of the state transition diagram performed in the step (C) (for example, processing of steps S112, S114, and S116 in the flowchart of FIG. 12); and (F) editing and updating the data based on results of the edit of the timeline performed in the step (D) or on results of the edit of the state transition diagram performed in the step (E) (for example, processing of steps S13 and S73 in the flowchart of FIGS. 5 and 10, respectively).

The data described above can contain rules of displaying animations, rules of processing events, and information about labels.

Where the corresponding rules of processing events are modified by the results of the edit of the timeline performed in the step (D) or by the results of the edit of the state transition diagram performed in the step (E), if a factor producing a state occurs, a step (G) of adding a new label of the same structure as the labels contained in the data, editing the data, and updating the data can be added to the step (F) for editing and updating the data (steps S13 and S73 in the flowcharts of FIGS. 5 and 10, respectively).

(i) When the corresponding rules of processing events are modified as a result of the edit performed in the step (D) for editing the timeline or (ii) when the corresponding rules of processing events are modified as a result of the edit of the transition state diagram because of the processing performed in the step for editing a state transition diagram, the step of processing events for editing and updating the rules of processing events regarding the data (for example, steps S54 and S114 in the flowcharts of FIGS. 9 and 12, respectively) can be contained. (iii) When the rules of processing events are edited and updated because of the processing performed in the step (G) for setting rules for processing events, if a factor producing a state as described previously occurs, the step of setting a label for newly creating information about a label (for example, processing of steps S56 and S116 in the flowcharts of FIGS. 9 and 12, respectively) can be contained. (iv) When the corresponding rules of displaying animations are modified as a result of the edit of the timeline by the processing performed in the step of editing a timeline or (v) when the corresponding rules of displaying animations are modified as a result of edit of the state transition diagram by the processing performed in the step of editing a state transition diagram, the step of setting rules of displaying rules for editing and updating the rules of displaying animations regarding the data (for example, processing of steps S52 and S112 in the flowcharts of FIGS. 9 and 12, respectively) can be further contained. In the processing of editing data, the data can be edited and updated (for example, processing of steps S13 and S73 in the flowcharts of FIGS. 5 and 10, respectively), based on (a) the rules of processing events created by the processing in the step of setting rules of events, (b) label information created by the processing in the step of setting labels, and (c) the rules of displaying animations created by the processing for setting rules of displaying animations.

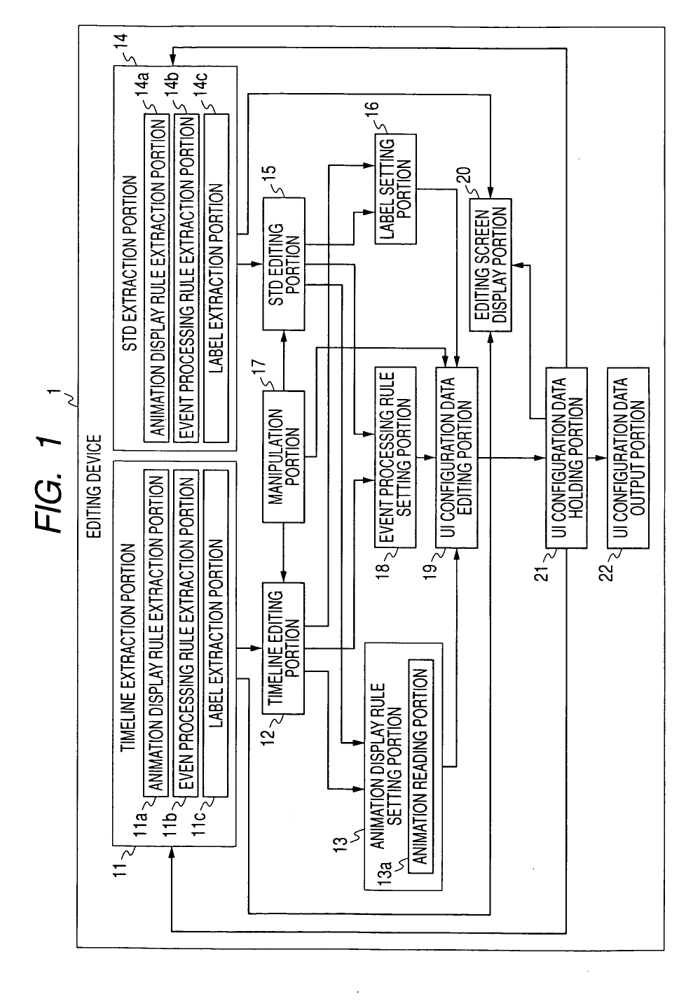

An information processor according to one embodiment of the present invention includes: (A) means (for example, timeline extraction portion 11 of FIG. 1) for creating a timeline based on data used in executing a user interface; (B) means (for example, state transition diagram (STD) extraction portion 14 of FIG. 1) for creating a state transition diagram based on the data; (C) means (for example, manipulation portion 17 of FIG. 1) for manipulating the timeline or the state transition diagram; (D) means (for example, timeline editing portion 12 of FIG. 1) for editing the timeline based on contents of the manipulation of the timeline by the manipulation performed by the manipulation means; (E) means (for example, state transition diagram (STD) editing portion 15 of FIG. 1) for editing the state transition diagram based on contents of the manipulation of the state transition diagram performed by the manipulation means; and (F) means (for example, UI configuration data editing portion 19 of FIG. 1) for editing and updating the data based on results of edit of the timeline performed by the timeline editing means or on results of the edit of the state transition diagram performed by the STD editing means.

FIG. 1 is a diagram showing the configuration of one example of an editing device 1 to which an embodiment of the present invention is applied.

The editing device 1 is a device for editing UI (user interface) configuration data. Although the editing device 1 can directly edit UI configuration data made up of text data by means of test editing, the editing device can also display the UI configuration data as a timeline or as a state transition diagram (STD). When a timeline or state transition diagram is edited by a user, the editing device can also edit the UI configuration data according to the contents of edit of the timeline or state transition diagram.

The UI configuration data includes rules of displaying animations, rules of processing events, and information about labels. Animation files for plural objects, respectively, are executed and displayed based on the rules of displaying animations, the rules being set for the animation file for each object. The timings at which the animations for each object are displayed are interrelated per unit time or unit frame based on the rules of processing events.

More specifically, the rules of displaying animations have information about start time and display period for each animation file. The rules define the periods for which the animations are displayed and the periods for which they are not displayed (e.g., display from 10 to 50 ms, non-display from 50 to 100 ms, and display from 100 to 120 ms). The rules for displaying animations can be defined similarly using frame numbers as well as using time displays alone. In the example given in following description, time is defined in units of 1 frame such as 30 fps. Of course, time is defined in units of frames other than the above-described frame rate.

The label information indicates the times of labels or frames. Each label is defined by an instant of time in a timeline or a frame number. Meanwhile, the label information is also a unit of state in a state transition diagram.

Rules of processing events determine the contents of processing for each event by defining reproduction positions in a timeline or states in a state transition diagram by produced events.

In this way, because of the rules of displaying animations, rules of processing events, and label information, development of an UI application program corresponding to a generated event can be made independent of development of animations (designs). Therefore, UIs corresponding to animations can be developed independent of UIs corresponding to events. Furthermore, UIs can be easily developed by splicing together existing animations, which is enabled simply by setting only rules of processing events. Consequently, the efficiency of development of UIs can be improved. Furthermore, an animation that is displayed as a UI in a given state, for example, can be easily replaced by another animation that is different in design or behavior, based on the rules of displaying animations and label information.

In the following embodiments, with respect to UI configuration data, UIs are accomplished by displaying plural animations at various timings. UIs executed by UI configuration data are not limited to UIs using animations. For instance, one example of the UI is reproduction of a so-called live-action motion picture sequence. Another example of the UI is data about a live-action motion picture sequence edited by computer graphics.

A timeline extraction portion 11 has an animation display rule extraction portion 11a, an event processing rule extraction portion 11b, and a label extraction portion 11c. These portions form timelines based on rules of displaying animations, rules of processing events, and information about labels. These kinds of information are read from UI (user interface) configuration data in a UI configuration data holding portion 21. The timelines are supplied to an editing screen display portion 20 made of a CRT (cathode ray tube), LCD (liquid crystal display), or the like. The extraction portions supply information forming the timelines to the timeline editing portion 12.

When a manipulation portion 17 including a computer mouse, pointer, and a keyboard is manipulated by a user, the timeline editing portion 12 recognizes the contents of edit of the timeline based on a manipulation signal produced in response to the manipulation, reads the recognized contents of the edit and information necessary for the edit of the corresponding UI configuration data from the timeline extraction portion 11, and supplies the contents to all of an animation display rule setting portion 13, an event processing rule setting portion 18, and a label setting portion 16.

A state transition diagram (STD) extraction portion 14 forms a state transition diagram based on animation display rules, event processing rules, and label information read from the UI configuration data of the UI configuration data holding portion 21 by an animation display rule extraction portion 14a, an event processing rule extraction portion 14b, and a label extraction portion 14c, respectively. The state transition diagram is supplied to the editing screen display portion 20 made of a CRT, LCD, or the like. Information forming the state transition diagram is supplied to the STD editing portion 15.

When the manipulation portion 17 made of the mouse, pointer, keyboard, and so on is manipulated by the user, the STD editing portion 15 recognizes the contents of the edit of the state transition diagram based on the manipulation signal produced in response to the manipulation, reads the recognized contents of the edit and information necessary to edit the corresponding UI configuration data from the STD extraction portion 14, and supplies the contents and information to the animation display rule setting portion 13, event processing rule setting portion 18, and label setting portion 16.

The animation display rule setting portion 13 gains the UI configuration data according to the contents of edit of the timeline or state transition diagram supplied from the timeline editing portion 12 or STD editing portion 15, sets the rules of displaying animations based on the gained UI configuration data and contents of edit, and supplies the set rules to the UI configuration data editing portion 19. The animation display rule setting portion 13 has an animation reading portion 13a. When the rules of displaying animations are edited, the reading portion reads a given animation file from an animation storage (not shown) according to the contents of the edit, and supplies the animation file to the UI configuration data editing portion 19 together with the rules of displaying animations.

The event processing rule setting portion 18 gains UI configuration data according to the contents of the edit of the timeline or state transition diagram supplied from the timeline editing portion 12 or STD editing portion 15, sets rules of processing events based on the gained UI configuration data and the contents of the edit, and supplies the rules to the UI configuration data editing portion 19.

The UI configuration data editing portion 19 edits and updates the UI configuration data stored in the UI configuration data holding portion 21 based on the animation display rules, event processing rules, and label information supplied from the animation display rule setting portion 13, event processing rule setting portion 18, and label setting portion 16. Furthermore, the UI configuration data editing portion 19 also can edit and update the UI configuration data stored in the UI configuration data holding portion 21 based on the animation display rules, event processing rules, and label edit information directly edited by the manipulation portion 17.

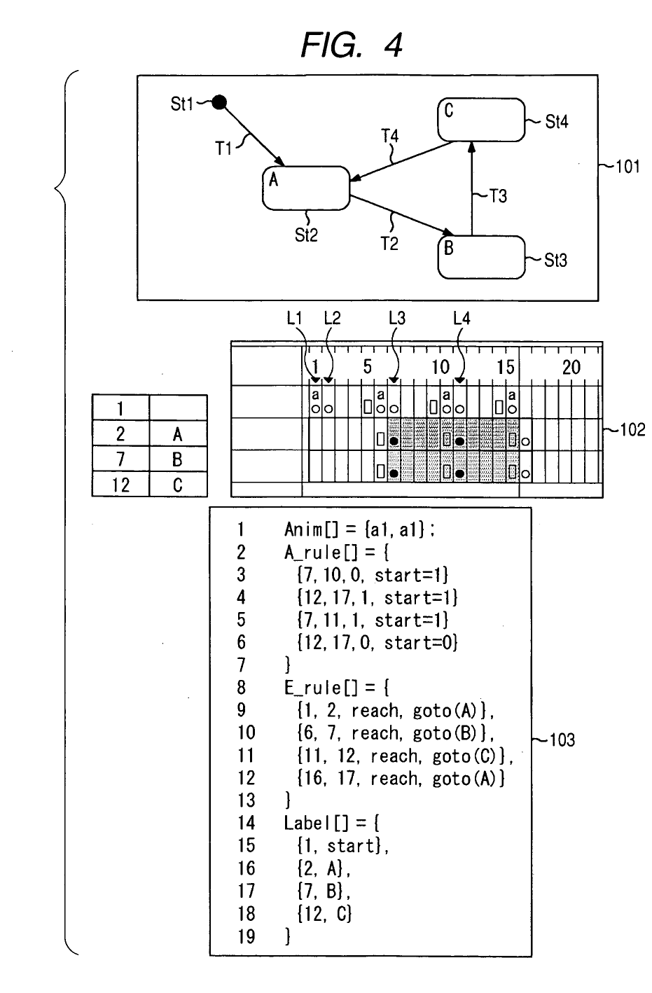

The editing screen display portion 20 displays editing windows respectively for the timeline supplied from the timeline extraction portion 11, state transition diagram supplied from the STD extraction portion 14, and UI configuration data held in the UI configuration data holding portion 21 separately on a display device (not shown). Of course, all of 3 windows (for example, windows 101-103 of FIG. 4) for displaying the state transition diagram, timeline, and UI configuration data can be displayed at the same time. Any one or any two of them can also be displayed. Each window is displayed based on the same UI configuration data and intended to edit the same UI configuration data. For example, when a window for editing of a timeline is edited, the state in which the windows for the state transition diagram and UI configuration data have been edited in a corresponding manner is displayed.

The UI configuration data holding portion 21 is made, for example, of a hard disc, and holds (stores) UI configuration data edited or updated by the UI configuration data editing portion 19. If necessary, the holding portion supplies the UI configuration data to the timeline extraction portion 11 or to the STD extraction portion 14.

A UI configuration data output portion 22 reads the UI configuration data held in the UI configuration data holding portion 21 and supplies the data to a reproduction apparatus 31 (described later).

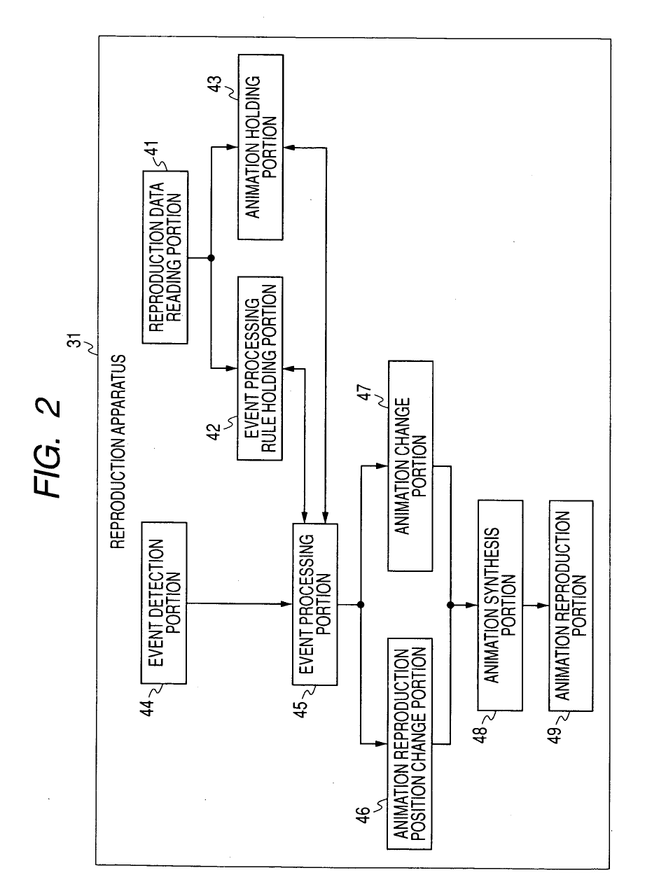

The configuration of one example of the reproduction apparatus 31 is next described by referring to FIG. 2.

The reproduction apparatus 31 reproduces the UI configuration data edited by the above-described editing device 1 of FIG. 1 and executes the data as a UI (user interface) in practice.

A reading portion 41 for data for reproduction reads in data to be reproduced and supplies the data to an event processing rule holding portion 42 and to an animation holding portion 43, the data being contained in the UI configuration data which has been edited by the editing device 1. The event processing rule holding portion 42 manages the rules of processing events, the rules describing the contents of processing of an event configured based on an event handler and label contained in the data for reproduction. The animation holding portion 43 extracts displayed animations and their respective rules of displaying animations from the UI configuration data read in by the reproduction data reading portion 41, holds them, and manages them. An event detection portion 44 informs an event processing portion 45 of the detected event.

The event processing portion 45 controls an animation reproduction position change portion (image data reproduction position change portion) 46 according to the generated event and based on the notice that an event has occurred, changes the reproduction position of animation held in the animation holding portion 43 based on the rules of displaying animations and on the rules of processing events, and supplies data about the changed position to an animation synthesis portion 48. The event processing portion 45 controls an animation change portion (image data change portion) 47, changes attributes (such as colors (including texture), pattern, sizes, and positions) of parts (such as buttons and characters) present within the animation based on the rules of displaying animations and on the rules of processing events, and supplies the information to the animation synthesis portion 48.

The animation synthesis portion (image data synthesis portion) 48 synthesizes fetched plural animations such that they can be treated as one animation, based on information about reproduction positions of animations supplied from the animation reproduction position change portion 46, parts within the animations supplied from the animation change portion 47, and their attribute information, and supplies the synthesized animation to an animation reproduction portion 49. The animation reproduction portion (image data reproduction portion) 49 reproduces the animation supplied from the animation synthesis portion 48 and displays the animation on the display device (not shown) made of a CRT or LCD.

Events include user events produced by manipulations (such as a user's clicking action on the mouse, a drag-and-drop action, and key entry) and system events produced when data are reproduced such as switching of the reproduced animation caused by a timer. Furthermore, events showing the state of operation can also be treated similarly. For example, that the remaining amount of a battery is low can be recognized as an event.

Processing for editing the UI configuration data performed by the editing device 1 is next described. Processing for reproducing the UI configuration data by the reproduction apparatus 31 is first described. The configuration of the UI configuration data is also described. Furthermore, the relationship among the UI configuration data, state transition diagram, and timeline is described.

In step S1, the event processing portion 45 controls the animation reproduction position change portion 46 and the animation change portion 47 based on the animation display rules read into the animation holding portion 43 from the reproduction data reading portion 41 such that a given animation and its reproduction position are output to the animation synthesis portion 48. The animation synthesis portion 48 synthesizes an animation based on information about the incoming given animations and the reproduction position and causes the animation reproduction portion 49 to display the synthesized animation on the display device (not shown). That is, in the first processing, the animation is reproduced irrespective of whether there is an event.

In step S2, the event processing portion 45 monitors the event detection portion 44 and makes a decision as to whether an event has occurred. For example, if the decision at step S2 is YES (an event has been detected), control goes to step S3, where the event processing portion 45 reads rules of processing events from the event processing rule holding portion 42 and makes a decision as to whether the contents of the detected event comply with the rules of processing events.

The configuration of the UI configuration data is now described by referring to FIG. 4.

In FIG. 4, there are shown the display window 101 for displaying an edit screen using a state transition diagram displayed by the editing device 1, a display window 102 for displaying an edit screen using a timeline, and a display window 103 used in a case where the UI configuration data is directly edited. The windows 101-103 are displayed based on the UI configuration data described in the window 103. Each row on the left side of the window 103 is given a row number for convenience of explanation. Usually, it is possible that the rows numbers are not displayed in the window 103.

The configuration of the UI configuration data is first described by referring to the UI configuration data described in the window 103 of FIG. 4.

The UI configuration data is made up of an animation pool, rules of displaying animations, rules of processing events, and information about labels.

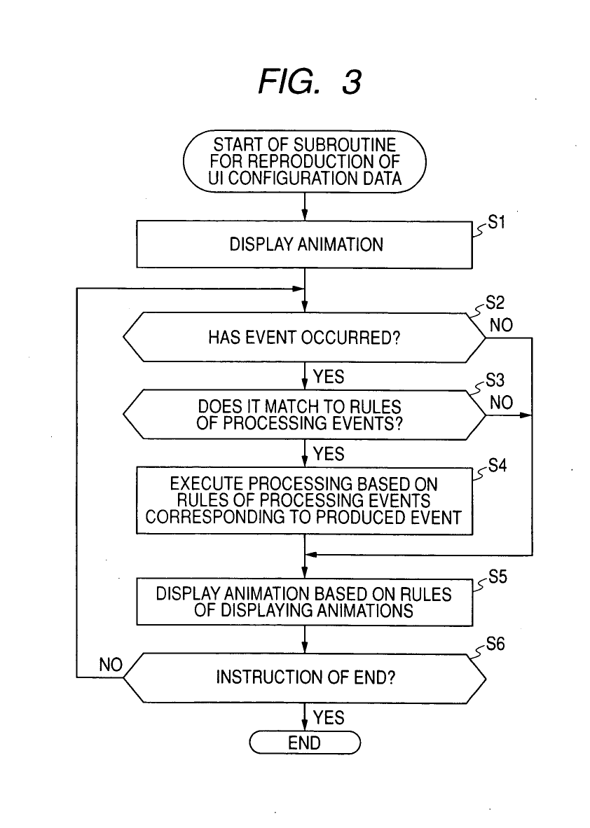

The animation pool is described as indicated, for example, by row number 1 in the window 103. In this description, it is shown that animation files indicated by “a1” and “a2” are used for display. In the example shown in FIG. 3, only two animation files are used. If there are more animation files, they are described within parentheses { }. In the following rules of displaying animations, IDs for identifying animations are 0 and 1. They are indicated by the animation files “a1” and “a2”, respectively.

The rules of displaying animations describe (i) a frame (frame number or instant of time indicating the timing at which an animation out of the whole animation sequence of UI is reproduced within the whole operation) at which a display is started during display of a sequence of animations, (ii) display end frame (frame number or instant of time indicating the timing at which an animation out of the whole animation sequence of UI is reproduced within the whole operation), (iii) IDs for identifying animation files, and (iv) the frame number of the display start frame within the animation file.

For example, in FIG. 4, the description of the rules of displaying animations is given after “A_rule [ ]” at row numbers 2 to 7. That is, a description “{7, 11, 0, start=1} is given at row number 3. It is set forth that animations from the first frame in animation file “a1” having an animation ID number of 0 are reproduced at timings from the seventh frame to a point immediately preceding the eleventh frame. A description {12, 17, 1, start=1} is given at row number 4. It is set forth that animations from the first frame in animation file “a2” having an animation ID number of 1 are reproduced at timings from the 12th frame to a point immediately preceding the 17th frame. Furthermore, a description {7, 11, 1, start=1} is given at row number 5. It is set forth that animations from the first frame in animation file “a2” having an animation ID number of 1 are reproduced at timings from the seventh frame to a point immediately preceding the eleventh frame. In addition, a description {12, 17, 0, start=0} is given at row number 6. It is set forth that animations from the first frame in animation file “a1” having an animation ID number of 0 are reproduced at timings from the twelfth frame to a point immediately preceding the seventeenth frame.

The rules of processing events are made of, for example, information about (i) start frame (frame number or instant of time indicating a timing during the whole process when the whole animation sequence of UI is reproduced) at which an event is switched, (ii) information about the end frame (frame number or instant of time indicating a timing during the whole process when the whole animation sequence of UI is reproduced), (iii) information for identifying each event, and (iv) information about the contents of processing. In FIG. 4, descriptions, for example, at row numbers 8 to 13 placed after “E_rule [ ]” in the window 103 provide a description of the rules of processing events. At row number 9, a description {1, 2, reach, goto (A)} is given. It is set forth that a start is made from the first frame and that control is made to jump to the frame set with label A when control arrives immediately ahead of the second frame. At row number 10, a description {6, 7, reach, goto (B)} is given. It is set forth that a start is made from the sixth frame and that control is made to jump to the frame set with label B when control arrives immediately ahead of the seventh frame. At row number 11, a description {11, 12, reach, goto (C)} is given. It is set forth that a start is made from the eleventh frame and that control is made to jump to the frame set with label C when control arrives immediately ahead of the twelfth frame. At row number 12, a description {16, 17, reach, goto (A)} is given. It is set forth that a start is made from the sixteenth frame and that control is made to jump to the frame set with label C when control arrives immediately ahead of the seventeenth frame.

The label information indicates a given processing interval, for example. In FIG. 4, descriptions at row numbers 9 to 14 in the window 103 provide a description of label information. Note that a description {1, start} is given at row number 10. It is only set forth that timings from the beginning to an instant immediately preceding the first frame provide the starting point of the processing.

A description {2, A} is given at row number 11. It is shown that the frames placed after the second frame provide the interval of the label A. A description {7, B} is given at row number 12. It is shown that the frames placed after the seventh frame provide the interval of the label B. Furthermore, at row number 13, a description {12, C]0 is given. It is shown that the frames placed after the twelfth frame provide the interval of the label C.

We now return to the description of the flowchart. However, details of the windows 101 and 102 will be described later.

For example, at step S3, if the detected event complies with the rules of processing events, control goes to step S4, where the event processing portion 45 executes processing which is described in the rules of processing events and which corresponds to the detected event. That is, the event processing portion 45 reads new rules of displaying animations and an animation file from the animation holding portion 43 as the need arises, based on the rules of processing events. The processing portion 45 supplies the rules and file to the animation reproduction position change portion 46 and to the animation change portion 47.

Accordingly, if the first processing, i.e., the decision at step S3, is YES (i.e., the event complies with the rules of processing events, for example, at row number 9), control goes to step S4, where the event processing portion 45 starts reproduction of animations. If an event indicating that the process has arrived at a timing immediately preceding the second frame is produced, then new rules of displaying animations and an animation file are read from the animation holding portion 43 such that event processing for causing control to jump to the second frame being the interval of the label A can be executed. The animations and file are supplied to the animation reproduction position change portion 46 and to the animation change portion 47.

At step S5, the animation reproduction position change portion 46 and animation change portion 47 supply the new animation reproduction position and animations to the animation synthesis portion 48 based on the animation display rules and animation file supplied from the event processing portion 45. The animation synthesis portion 48 synthesizes plural modified animations based on information about the animation reproduction position, and displays the animations as a UI on the animation reproduction portion 49.

At step S6, the event processing portion 45 makes a decision as to whether an event commanding the display of the UI to be ended has been detected by the event detection portion 44. If the decision is NO (such an event is not detected), control returns to step S2, where the subsequent process steps are repeated.

If the decision at step S2 is that no event is produced or if the decision at step S3 is that the event does not comply with the rules of processing events, the processing of step S4 is skipped. That is, in this case, any processing based on the rules of processing events is not performed and so the present status is maintained.

If the decision at step S6 is YES (i.e., an event commanding the end has been detected), this processing is ended.

Because of the operations described so far, the UI is executed based on the UI configuration data.

Editing of the UI configuration data is next described. As described previously, the UI configuration data can be expressed either by a timeline or by a state transition diagram and, therefore, the UI configuration data can be edited if the data is displayed in either format.

Before describing the editing, the relationships among the UI configuration data, timeline, and state transition diagram are described by referring to FIG. 4. First, the relationship between the UI configuration data and state transition diagram is described.

As described previously, descriptions at row numbers 9 to 12 in the UI configuration data set forth in the window 103 state that jumps to frames 2, 7, 11, and 2 are made at timings immediately preceding frames 2, 7, 12, and 17, respectively. Accordingly, where a state transition diagram is discussed, it can be considered that conditions under which the state makes a transition are set forth. Since the transition destination (the destination frame of the jump when an event has occurred) is a frame number that has been determined as label information, each label can be regarded as a state. Therefore, a state transition diagram based on the UI configuration data described in the window 103 is displayed as shown in the window 101. That is, labels “A”, “B”, and “C” are expressed as states A to C, respectively, and as state frames St2 to St4, respectively. The label “start” gives only the starting point of the processing as described previously. Therefore, the label is expressed as state frame St1 but is different from a general state.

According to the description at row number 9, if control arrives immediately ahead of the second frame from the starting point at which the processing is started, control jumps to the second frame. Consequently, the state makes a transition from the starting point to the state A. Accordingly, in this case, state transition T1 indicating the direction of a transition is shown to be directed from the state frame St1 toward the state frame St2.

According to the description at row number 10, control jumps to the seventh frame when control arrives immediately ahead of the seventh frame from the sixth frame. As a result, the state makes a transition from state A to state B. Therefore, in this case, state transition T2 indicating the direction of transition is shown to be directed toward state frame St3 from state frame St2.

According to the description at row number 11, control jumps to the twelfth frame when control arrives immediately ahead of the twelfth frame from the eleventh frame. As a result, the state makes a transition from state B to state C. Accordingly, in this case, state transition T3 indicating the direction of transition is shown to be directed toward state frame St4 from state frame St3.

According to the description at row number 12, control jumps to the second frame when control arrives immediately ahead of the seventeenth frame from the sixteenth frame. As a result, the status makes a transition from state C to state A. Accordingly, in this case, state transition T4 indicating the direction of transition is shown to be directed toward state frame St4 from state frame St2.

As a result, the UI configuration data in the window 101 is expressed as a state transition diagram in the window 101.

The relationship between the UI configuration data and timeline is next described.

The aforementioned descriptions at row numbers 9 to 12 in the window 103 of FIG. 4 set forth generation of events in frames 2, 7, 12, and 17. Accordingly, an interval where an event has occurred is marked, for example, with symbol “a” and a circlet. Therefore, in the right portion of the window 102 of FIG. 4, symbol “a” and a circlet are marked from the second stage as counted from the above in each of the first, sixth, eleventh, and sixteenth frames. The head position of the interval of animation is marked with a circlet. That is, in a frame next to the timing at which an event has occurred, an interval of animation is started. Therefore, each of the second, seventh, and twelfth frames is marked with a circlet, showing beginning of an interval. Furthermore, the head position at which a label is set is shown. In the window 102 of FIG. 4, a black convex triangle is marked under each of labels L1 to L4. On the left side of the window 102 of FIG. 4, a label list corresponding to labels L1 to L4 is shown. Start frame numbers are shown on the left side of the figure, based on the descriptions given after “Label [ ]” at row numbers 14 to 19 in the UI configuration data in the window 103. On the right side, information for identifying each label is shown.

In the right portion of the window 102 of FIG. 4, the memory at the top stage indicates a frame number. The second stage indicates an interval corresponding to an event. The third and fourth stages indicate timings at which animation files “a1” and “a2” are respectively shown.

More specifically, the contents of the left portion at the third stage correspond to the description at row number 3 of the rules of displaying animations. It is shown that the animation file “a1” is displayed from the first frame at timings from the seventh frame to a point immediately preceding the eleventh frame in a sequence of operations expressing the UI. The contents of the right portion at the third stage correspond to the description at row number 4 in the rules displaying animations. It is shown that the animation file “a2” is displayed from the first frame at timings from the twelfth frame to a point immediately preceding the seventeenth frame in the sequence of operations expressing the UI.

The contents of the left part of the fourth stage correspond to the description at row number 5 in the rules of displaying animations. It is shown that the animation file “a2” is displayed from the first frame at timings from the seventh frame to an instant immediately preceding the eleventh frame in a sequence of operations expressing the UI. The contents of the right part of the fourth stage correspond to the description at row number 6 in the rules of displaying animations. It is shown that the animation file “a1” is displayed from the first frame at timings from the twelfth frame to an instant immediately preceding the seventeenth frame in the sequence of operations expressing the UI. In FIG. 4, each black circle indicates generation of an event caused by key entry. Each vertically elongated rectangle indicates the end position of an interval started by an event which was generated by key entry.

Processing (subroutine) for editing a timeline displayed based on the above-described UI configuration data by the editing device 1 to edit the UI configuration data is next described by referring to the flowchart of FIG. 5.

At step S11, the timeline extraction portion 11 executes the subroutine for displaying a timeline.

The subroutine for displaying a timeline is now described by referring to the flowchart of FIG. 6.

At step S31, the animation display rule extraction portion 11a of the timeline extraction portion 11 extracts and reads information about rules of displaying animations from the UI configuration data held in the UI configuration data holding portion 21. For example, in the case of the UI configuration data in the window 103 of FIG. 4, information at row numbers 2 to 7 is read out.

At step S32, the timeline extraction portion 11 reads out information about the interval of each animation file based on the animation display rules read out. That is, in the case of the UI configuration data in the window 103 of FIG. 4, information about the intervals described at row numbers 3 to 6 is read out.

At step S33, the timeline extraction portion 11 images the information about the interval of the animation based on the information about the interval of the animation read out and displays the drawn image on the editing screen display portion 20. That is, in the case of FIG. 4, display intervals of animations are imaged as shown at the third and fourth stages of the timeline shown in the window 102.

At step S34, the event processing rule extraction portion 11b extracts and reads out information about the rules of processing events from the UI configuration data held in the UI configuration data holding portion 21. For example, in the case of the UI configuration data in the window 103 of FIG. 4, information at row numbers 8 to 13 is read out.

At step S35, the timeline extraction portion 11 images the information about the rules of processing events based on the information about the rules of processing events read out, and displays the drawn image on the editing screen display portion 20. That is, in the case of FIG. 4, the starting position of the interval and the position at which an event occurs are imaged as shown at the second stage of the timeline shown in the window 102.

At step S36, the label extraction portion 11c extracts and reads out information about a label from the UI configuration data held in the UI configuration data holding portion 21. For example, in the case of the UI configuration data in the window 103 of FIG. 4, information at row numbers 14 to 19 is read out.

At step S37, the timeline extraction portion 11 draws pictures of the labels based on the information about the label read out and displays the pictures on the editing screen display portion 20. That is, in the case of FIG. 4, the labels are drawn as indicated by labels L1 to L4 of the timeline shown in the window 102.

Because of the processing described so far, the window 102 for editing the timeline is displayed based on the UI configuration data and so the user can recognize the state in which the UI configuration data to be edited is expressed as a timeline.

We now return to the description of the flowchart of FIG. 5.

At step S12, the timeline editing portion 12 makes a decision as to whether the timeline has been edited by manipulating the manipulation portion 17.

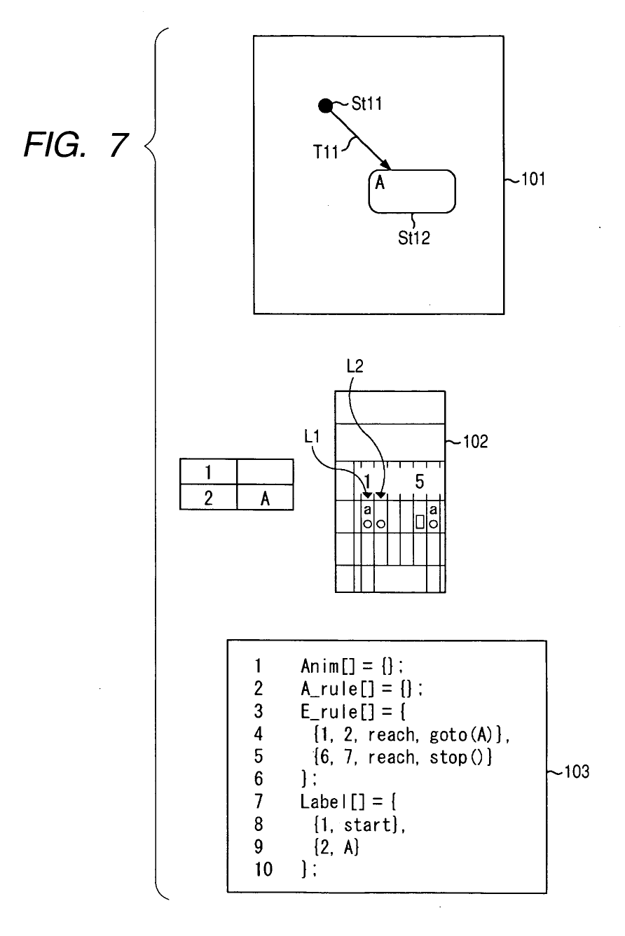

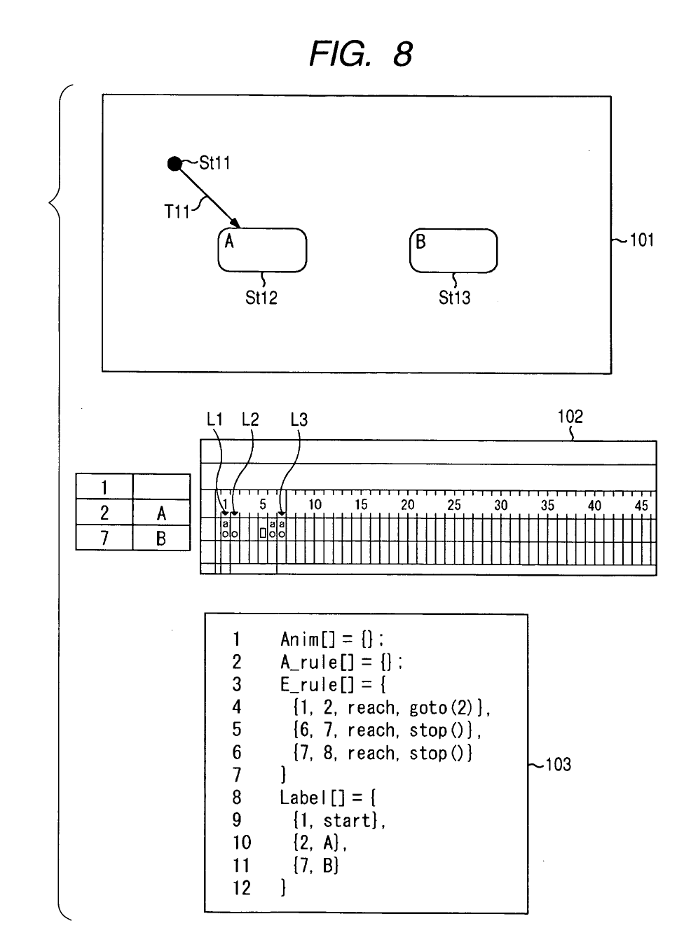

In the description provided now, an example is taken in which new rules of processing events are added as shown in FIG. 8, for example, when the UI configuration data is in the initial condition as shown in FIG. 7.

In FIG. 7, an animation file is described at row number 1 as shown in the window 103 of the UI configuration data. However, because of the initial condition, a file name specifying an animation has not been entered. At row number 2, rules of displaying an animation are described but the rules themselves are not written because also in the initial condition.

At row numbers 3 to 6, rules of processing events are described. Among them, a description {1, 2, reach, goto (A)} is given at row number 4. It is shown that control jumps to the frame set with the label A on arriving immediately ahead of the second frame after starting from the first frame. Similarly, a description {6, 7, reach, stop ( )} is given at row number 5. It is shown that control stops when arriving immediately ahead of the seventh frame after starting from the sixth frame.

Information about labels is described at row numbers 7 to 10. At row number 8, a label providing a basis is shown. At row number 9, a description {2, A} is given. It is shown that frames located after the second frame are the interval of the label A.

If these kinds of information are displayed by a timeline, a state as shown in the window 102 of FIG. 7 is obtained. That is, at the second stage, a symbol “a” and a white circlet are marked at the position of the first frame. Thus, the rules of processing events at row number 4 of the UI configuration data are reflected. At the second stage, the symbol “a” and a white circlet are marked at the position of the sixth frame. Thus, the rules of processing events at row number 5 of the UI configuration data are reflected. Furthermore, labels L1 and L2 are described based on label information. The number given to the starting frame is shown in the left part of the window 102. Information for identifying each label is recorded on the right side. In FIG. 7, there is no label for the first frame providing a starting point of processing. Intervals from the second frame are set to the label A.

That is, where the timeline takes the form of the timeline in the window 102 shown in FIG. 7, the manipulation portion 17 is manipulated, for example. If symbol “a” and a white circlet are newly added to the seventh frame as shown in the window 102 of FIG. 8, and if the decision is that the timeline has been edited, it is regarded that there is a modification. At step S13, the subroutine for editing the UI configuration data based on the manipulation for editing the timeline is performed.

The subroutine for editing the UI configuration data based on the manipulation for editing the timeline is now described by referring to the flowchart of FIG. 9.

At step S51, the timeline editing portion 12 makes a decision as to whether the rules of displaying animations have been modified based on the manipulation for editing the timeline from the contents of the manipulation of the manipulation portion 17. For example, if the decision is that the rules of displaying animations have been modified, control goes to step S52, where the timeline editing portion 12 supplies the information about the modified rules of displaying animations to the animation display rule setting portion 13 according to the contents of the manipulation from the manipulation portion 17. The animation display rule setting portion 13 creates the rules of displaying animations out of the UI configuration data based on the information about the contents of the modification, and supplies the rules to the UI configuration data editing portion 19. The UI configuration data editing portion 19 updates and stores the UI configuration data held in the UI configuration data holding portion 21 according to the newly supplied rules of displaying animations, based on the manipulation for editing.

At step S53, the timeline editing portion 12 makes a decision as to whether the rules of processing events have been modified based on the manipulation for editing the timeline, from the contents of the manipulation of the manipulation portion 17. For example, if the decision is YES (i.e., the rules of processing events have been modified), control goes to step S54, where the timeline editing portion 12 supplies the information about the modified rules of processing events to the event processing rule setting portion 18 according to the contents of the manipulation from the manipulation portion 17. The event processing rule setting portion 18 creates the event processing rules out of the UI configuration data based on the information about the contents of the modification, and supplies the created rules to the UI configuration data editing portion 19. The UI configuration data editing portion 19 updates and stores the UI configuration data held in the UI configuration data holding portion 21 according to the newly supplied rules of processing events based on the manipulation for editing.

For example, where the timeline is manipulated by the manipulation portion 17 such that a new interval is created in the seventh frame to make a transition from the state shown in FIG. 7 to the state shown in FIG. 8, a new description {7, 8, reach, stop ( )} is given as new rules of processing events as indicated by row number 6 in the window 103 of FIG. 8 because of the processing in step S54. A new description is given which stops the process when control arrives immediately ahead of the eighth frame from the seventh frame.

At step S55, the timeline editing portion 12 makes a decision as to whether a factor producing a state has occurred (as to whether the label information has been modified) based on the manipulation for editing the timeline, from the contents of the manipulation of the manipulation portion 17. Generation of a factor producing a state means that conditions under which label information in a given frame is updated (a label is attached) have been satisfied. Examples of the frame conditions under which a label is attached include (i) the frame is the head frame of a sequence of animations to be displayed (the head frame of the timeline being edited), (ii) the label is the frame specified by the user, (iii) the frame is the head frame whose operation is specified by the rules of processing events, (iv) the frame is a frame whose operation is specified by an event produced by key manipulation, and (v) the frame is a frame next to the final frame of a sequence of operations specified by an event produced by key manipulation. The “state” is one condition expressed by the state frame in a state transition diagram. The label indicates an interval in which one continuous operation is executed in a timeline. The interval in which one continuous operation is executed corresponds to a state in a state transition diagram. Accordingly, attaching a label has the same meaning as when the number of states is increased by one.

In this case, new rules of processing events are added to the seventh frame as shown in FIG. 8 and thus the rules are updated. Consequently, new rules of processing events are set in the head frame. Accordingly, decision at step S55 is that a factor producing a state has occurred, i.e., there are conditions under which a new label is attached. Therefore, control goes to step S56.

At step S56, the timeline editing portion 12 informs the label setting portion 16 that there are conditions under which a label is attached. Based on the notification, the label setting portion 16 creates information about the newly generated label and supplies the information to the UI configuration data editing portion 19. The UI configuration data editing portion 19 updates the UI configuration data held in the UI configuration data holding portion 21 to the newly supplied information about the label based on the manipulation for editing and stores the updated data.

For example, in this case, because of this processing, a description {7, B} is provided as given at row number 11 as shown in the window 103 of FIG. 8. The seventh frame is described as the starting position of the interval of the new label as shown in the label list on the left side of the window 102. “B” is set as a label name.

If the decision at step S51 is that the rules of displaying animations have not been modified, the processing of step S52 is skipped. If the decision at step S53 is that the rules of processing events have not been modified, the processing of steps S54 to S56 is skipped. If the decision at step S55 is that any factor producing a state has not occurred, the processing of step S56 is skipped.

As the processing for editing the UI configuration data is processed based on the manipulation for editing the timeline as described so far, the UI configuration data is rewritten. Control then returns to step S11 (FIG. 5). The following processing is repeated. Accordingly, if the UI configuration data is rewritten, the windows 101, 102, and 103 are displayed based on the UI configuration data in which the updated information has been reflected, during the processing of step S1. Therefore, if a label is attached as described previously, for example, the label L3 is drawn and displayed as shown in FIG. 8.

Because of the operations described so far, the UI configuration data can be edited by editing a timeline having intervals whose lengths (state lengths) can be easily recognized.

Processing for editing UI configuration data by editing a state transition diagram displayed based on the aforementioned UI configuration data by the editing device 1 is next described by referring to the flowchart of FIG. 10.

At step S71, the STD extraction portion 14 executes processing for displaying a state transition diagram.

The processing for displaying a state transition diagram is now described by referring to the flowchart of FIG. 11.

At step S91, the label extraction portion 14c of the STD extraction portion 14 extracts and reads out information about the label from the UI configuration data held in the UI configuration data holding portion 21. For example, in the case of the UI configuration data in the window 103 of FIG. 7, information at row numbers 7 to 10 is read out.

At step S92, the timeline extraction portion 11 draws a state frame based on the read information about the label and displays the drawn frame on the editing screen display portion 20. That is, in the case of FIG. 7, a state frame St11 providing a starting point is drawn based on the description at row number 8 as shown in the window 101. Based on the description at row number 9, a state frame St12 about the state A corresponding to the label A is drawn.

At step S93, the event processing rule extraction portion 14b extracts and reads out information about the rules of processing events from the UI configuration data held in the UI configuration data holding portion 21. For example, in the case of the UI configuration data in the window 103 of FIG. 7, information at row numbers 3 to 6 is read out.

At step S94, the STD extraction portion 14 images the state transition based on the information about the read rules of processing events and displays the drawn image on the editing screen display portion 20. That is, in the case of FIG. 7, a process is described in which control jumps to the state A corresponding to the label A on reaching a timing immediately preceding the second frame based on the description at row number 4 shown in the window 103. Therefore, as shown in the window 101, an arrow indicating state transition T11 that starts at the state frame St11 and ends at St12 is drawn.

At step S95, the animation display rule extraction portion 14a of the STD extraction portion 14 extracts and reads out information about the rules of displaying animations from the UI configuration data held in the UI configuration data holding portion 21. For example, in the case of the UI configuration data in the window 103 of FIG. 4, information at row numbers 2 to 7 is read out.

At step S96, the STD extraction portion 14 reads out information about the intervals of animation files based on the read rules of displaying animations. That is, in the case of the UI configuration data in the window 103 of FIG. 4, information about intervals described at row numbers 3 to 6 is read out.

At step S97, the timeline extraction portion 11 draws a picture of the information about the read animation interval and a picture of the animation file name in the corresponding state frame and displays the pictures on the editing screen display portion 20. In FIG. 7, only text is displayed within the state frame St12 in the window 101 and hence is not shown in the figure. The animation file name may also be displayed separately within the state frame. For example, the animation file name may be displayed in the form of an icon within the state frame.

Because of the processing described so far, the window 101 for editing the state transition diagram is displayed based on the UI configuration data and, therefore, the user can recognize the state in which the UI configuration data to be edited is expressed as a state transition diagram.

We now return to the description of the flowchart of FIG. 10.

At step S72, the STD editing portion 15 makes a decision as to whether the state transition diagram has been edited by manipulation of the manipulation portion 17.

In the description provided now, an example is taken in which new rules of processing events are added as shown in FIG. 8 when the UI configuration data is in its initial condition, for example, as shown in FIG. 7.

That is, in the case of the state transition diagram in the window 101 shown in FIG. 7, if the decision is that an edit has been performed, for example, by manipulating the manipulation portion 17 and the state frame St13 is described in a state transition diagram as shown in the window 101 of FIG. 8, processing for editing the UI configuration data is executed based on a manipulation for editing the state transition diagram at step S73.

The processing for editing the UI configuration data based on a manipulation for editing a timeline is now described by referring to the flowchart of FIG. 12.

At step S111, the STD editing portion 15 makes a decision as to whether the rules of displaying animations have been modified based on a manipulation for editing the state transition diagram from the contents of the manipulation of the manipulation portion 17. For instance, if the decision is that the rules of displaying animations have been modified, the STD editing portion 15 supplies information about the modified rules of displaying animations according to the contents of the manipulation from the manipulation portion 17 to the animation display rule setting portion 13. The animation display rule setting portion 13 creates rules of displaying animations out of the UI configuration data based on the information about the contents of the modification, and supplies the created rules to the UI configuration data editing portion 19. The UI configuration data editing portion 19 updates and stores the UI configuration data held in the UI configuration data holding portion 21 according to the newly supplied rules of displaying animations based on the manipulation for editing.

At step S113, the STD editing portion 15 makes a decision from the contents of the manipulation of the manipulation portion 17 as to whether the rules of processing events have been modified based on the manipulation for editing the state transition diagram. For example, if the decision is that the rules of processing events have been modified, the STD editing portion 15 supplies information about the modified rules of processing events to the event processing rule setting portion 18 according to the contents of the manipulation from the manipulation portion 17 at step S114. The event processing rule setting portion 18 creates rules of processing events out of the UI configuration data based on information about the contents of the modification and supplies the rules to the UI configuration data editing portion 19. The UI configuration data editing portion 19 updates and stores the UI configuration data held in the UI configuration data holding portion 21 according to the newly supplied rules of processing events based on the manipulation for editing.

For example, where a new state has been added to make a transition from the state shown in FIG. 7 to the state shown in FIG. 8, processing is performed similarly to the case where a timeline for the minimum interval is produced. Because of the processing of step S114, a new description {7, 8, reach, stop ( )} is given as new rules of processing events as indicated at row number 6 in the window 103 of FIG. 8. A new description is given which stops the process when control arrives immediately ahead of the eighth frame from the seventh frame. Where a new state is added, a transition to other state is not made when expressed in terms of a timeline. That is, the state is that control does not jump to any other frame if a given interval ends. Therefore, where a new state is added, “stop ( )” is set as rules of processing events.

At step S115, the STD editing portion 15 makes a decision from the contents of the manipulation of the manipulation portion 17 as to whether a factor producing a state has occurred (as to whether label information has been modified) based on the manipulation for editing the state transition diagram. As described previously, state and label in a state transition diagram can be treated identically. Where a state frame is added, the number of states is increased by one. Therefore, it follows that a factor producing a state has taken place.

Accordingly, the decision at step S115 is that there are conditions under which a new label is attached. Control proceeds to step S116.

At step S116, the STD editing portion 15 informs the label setting portion 16 that there are conditions under which a label is attached. The label setting portion 16 creates information for producing a new label based on the notification and supplies the information to the UI configuration data editing portion 19. The UI configuration data editing portion 19 updates the UI configuration data held in the UI configuration data holding portion 21 to the newly supplied information about a label based on the manipulation for editing and stores the information.

For example, in this case, because of the processing, a description {7, B} is given as indicated at row number 11 as shown in the window 103 of FIG. 8.

At step S111, if the decision is that the rules of displaying animations have not been modified, the processing of step S112 is skipped. If the decision at step S113 is that the rules of processing events have not been modified, the processing of steps S114 to S116 is skipped. If the decision at step S115 is that any factor producing a state has not been produced, the processing of step S116 is skipped.

Because of the processing for editing the UI configuration data based on the manipulation for editing the state transition diagram as described so far, the UI configuration data is newly rewritten. Control returns to step S71 (FIG. 5). The subsequent processing is repeated. Accordingly, if the UI configuration data is rewritten, the updated information is reflected in the processing of step S71. The windows 101, 102, and 103 are displayed based on the UI configuration data. Therefore, if a label is attached as described above, for example, the label L3 is drawn and displayed as shown in FIG. 8.

According to the embodiment described so far, the UI configuration data can be edited by editing a state transition diagram that can be easily recognized visually.

Furthermore, as described previously, UI configuration data can be expressed either in a state transition diagram or in a timeline and so the UI configuration data can be edited in any one of the two forms. The results of an edit of the state transition diagram can be reflected in the UI configuration data and in the timeline. Conversely, the results of an edit of the timeline can be reflected in the UI configuration data and in the state transition diagram.

In addition, the UI configuration data can be expressed in any one of state transition diagram and timeline and so interchange ability can be attained between the state transition diagram and timeline. The timeline can be edited using the state transition diagram. Also, the state transition diagram can be edited using the timeline.

Although UI configuration data can be expressed either in a state transition diagram or in a timeline, it is desirable to select and edit which one of the state transition diagram and timeline depending on what information is edited. That is, in a case where the state length is modified in a state transition diagram, for example, it is necessary to perform an edit by a work in which text data in UI configuration data is directly updated. Accordingly, in this case, editing of the state length can be facilitated by performing an edit using a timeline. Conversely, regarding to what state control should control jump depending on the produced event, it is difficult to grasp the target state using a timeline. Therefore, editing of the relationship between the event and a corresponding operation can be facilitated by performing an edit using a state transition diagram.

In the description of the embodiment provided so far, an example of edit of UI configuration data is described in a case where one state is added in a state transition diagram, i.e., one interval in which an animation is displayed is added when a given event occurs in a timeline. The contents of edit are not limited to this example.

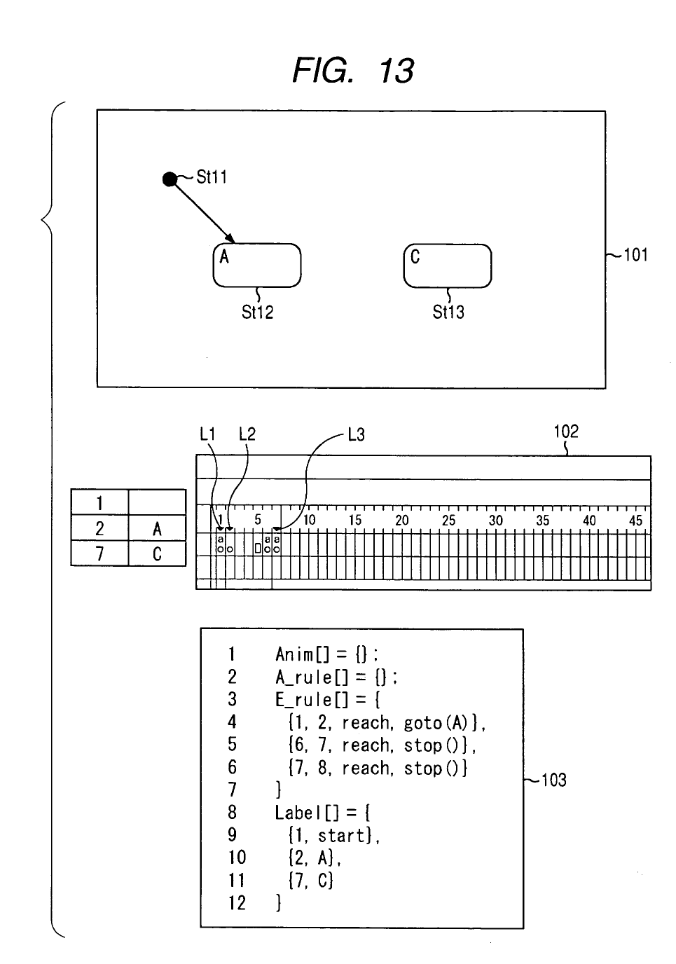

An example of edit is described below.

Where there is processing for editing a state transition diagram to change the state name of a state frame St13 in the window 101 of FIG. 8 from B to C, for example, as shown in FIG. 13, information about labels in the UI configuration data is correspondingly edited. More specifically, a description {7, B} at row number 11 shown in the window 103 of FIG. 8 is edited to a description {7, C} at row number 11 shown in the window 103 of FIG. 13. Because the UI configuration data is edited, with respect to the timeline, the notation at the lowest stage of the label list shown in FIG. 8 is changed from B to C as shown in the window 102 of FIG. 13. The label L3 is changed from state B to C. Processing for editing the UI configuration data and timeline when a manipulation for editing the state transition diagram is performed has been described. Conversely, when the timeline is edited, the UI configuration data and state transition diagram are similarly edited.

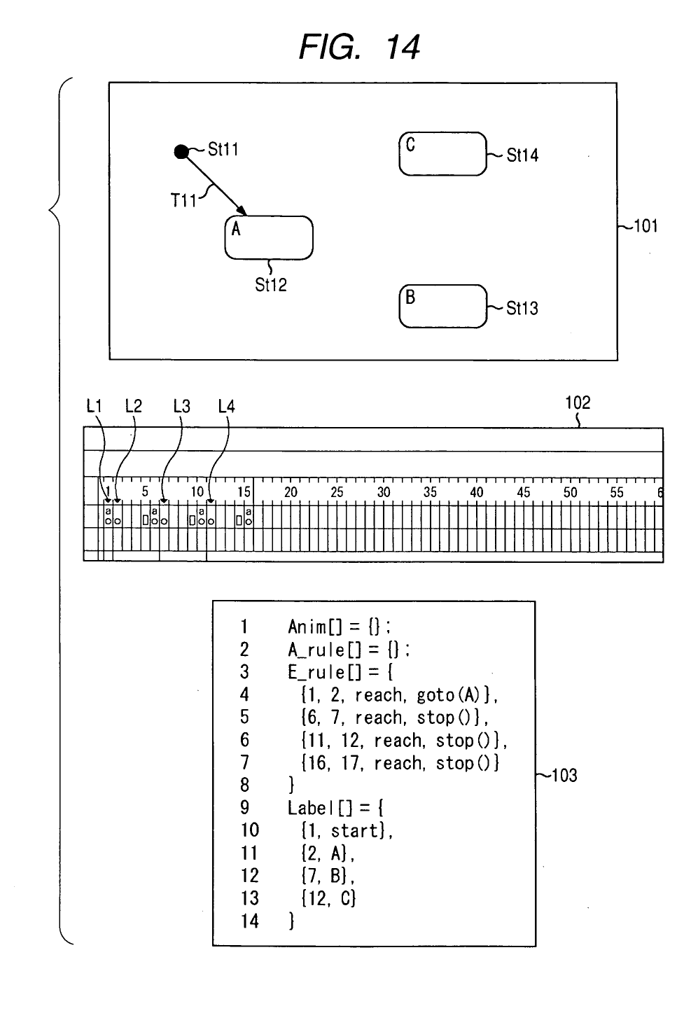

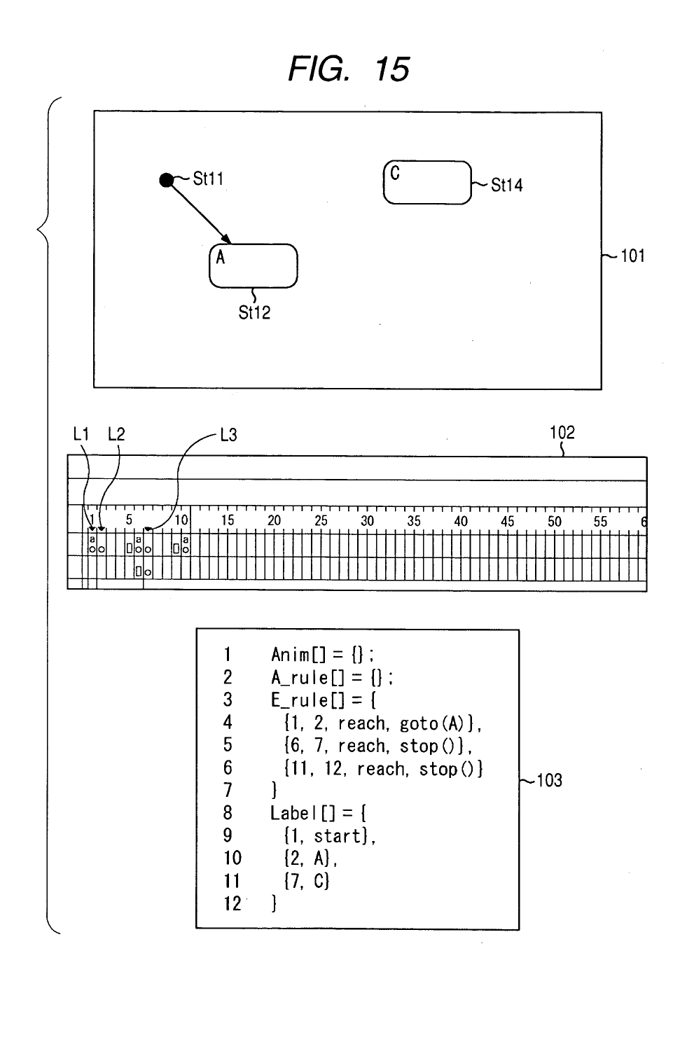

Furthermore, where the state transition diagram is edited as shown in FIG. 15 from the state, for example, shown in FIG. 14 and the state frame St13 is erased, the UI configuration data and timeline are edited in the manner described below.

In FIG. 14, it is assumed that state frames St11 to St14 are present and state transition T11 exists in the window 101. At this time, with respect to a timeline, symbol “a” and a circlet indicating generation of an event and start of a new interval are marked in each of first, sixth, eleventh, and sixteenth frames as shown in the window 102 of FIG. 14.

Additionally, with respect to UI configuration data, row number 1 indicates an animation pool, while row number 2 indicates rules of displaying animations as shown in the window 103. In FIGS. 14 and 15, description of the animation pool and rules of displaying animations is omitted to illustrate status and processing in each interval.

The rules of processing events are described at row numbers 3 to 8. At row number 4, information about the starting point is described. At row number 5, it is set forth that a region from the second frame to a point immediately preceding the seventh frame forms one interval (state A). At row number 6, it is set forth that a region from the seventh frame to a point immediately preceding the twelfth frame forms one interval (state B). At row number 7, it is set forth that a region from the twelfth frame to a point immediately preceding the seventeenth frame forms one interval (state C).

At row numbers 9 to 13, information about labels is described. At row number 10, information about the starting point is described. At row number 11, it is set forth that a label A (state A) starts from the second frame. At row number 12, it is set forth that a label B (state B) starts from the seventh frame. At row number 13, it is set forth that a label C (state C) starts from the twelfth frame.

At this time, as shown in the window 101 of FIG. 15, when the state frame St13 is deleted, row numbers 6 and 12 of the window 103 of FIG. 14 that are descriptions of state B corresponding to the deleted state frame St13 are deleted. The resulting description is as shown in the window 103 of FIG. 15. That is, according to the description in the timeline, frame numbers are crowded. In particular, the description at row number 6 in the window 103 of FIG. 14 corresponds to descriptions in the seventh to twelfth frames in the timeline. Therefore, the descriptions are edited such that those portions are slid to the left side in the figure. Consequently, the description of row number 7 in the window 103 of FIG. 14 shifts. In the window 103 of FIG. 15, the description is modified as at row number 6. With respect to information about labels, the description at row number 12 in the window 103 of FIG. 14 that is a description of the label B corresponding to the state B is deleted. The description is modified as at row numbers 8 to 12 in the window 103 of FIG. 15.

With respect to the timeline, the descriptions in the seventh to twelfth frames in the window 102 of FIG. 14 are correspondingly deleted. The descriptions in the twelfth to sixteenth frames are made to slide in the leftward direction in the figure. As shown in the window 102 of FIG. 15, the descriptions are modified as in the seventh to twelfth frames.

With respect to this processing, too, if the timeline is edited as shown in the window 102 of FIG. 15, the state transition diagram and UI configuration data shown in the windows 101 and 102 of FIG. 15 are similarly produced as a result of editing.

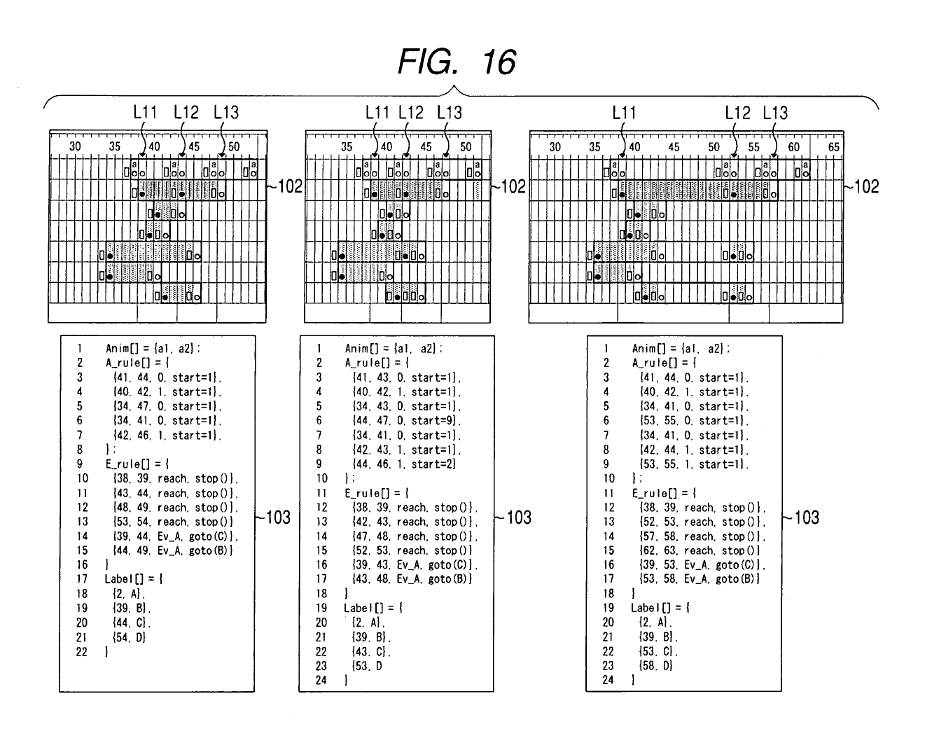

Furthermore, in a case where there is a window 102 indicating a timeline as shown in a left upper part of FIG. 16 and UI configuration data assumes a form as shown in the window 103 in a left lower part of FIG. 16 in a corresponding manner, for example, if the state length is reduced, the result of edit is as shown in the window 102 shown in a central upper part of FIG. 16 and in the window 103 shown in a central lower part. Conversely, if the state length is increased, an edit is performed as shown in the window 102 shown in a right upper part of FIG. 16 and as shown in the window 103 in a right lower part.

In the window 102 in the left upper part of FIG. 16, rules of processing events are described at the top stage and at the second stage. Especially, the description at the second stage corresponds to the descriptions at row numbers 14 and 15 in the windows 103 in the left lower part of FIG. 16. At row number 14, it is set forth that in the case of a voltage of Ev_A, control jumps to the frame of the label C from the 39th frame to a point immediately preceding 44th frame. At row number 15, it is set forth that in the case of a voltage of Ev_A, control jumps to the frame of the label B from the 44th frame to a point immediately preceding 49th frame.

At the third stage in the window 102 in the left upper part of FIG. 16, a timing is shown at which an animation is displayed based on the rules of displaying animations corresponding to the description at row number 3 in the window 103 in the left lower part of FIG. 16. At row number 3 in the window 103 in the left lower part of FIG. 16, it is set forth that an animation with ID=0 and in an animation file corresponding to “a1” is reproduced from the first frame of the animation file from the 41st frame to a point immediately preceding the 44th frame.

At the fourth stage in the window 102 in the left upper part of FIG. 16, a timing is shown at which an animation is displayed based on the rules of displaying animations corresponding to the description at row number 4 in the window 103 in the left lower part of FIG. 16. At row number 4 in the window 103 in the left lower part of FIG. 16, it is set forth that an animation with ID=1 and in an animation file corresponding to “a2” is reproduced from the first frame of the animation file at timings from the 40th frame to a point immediately preceding the 42nd frame.

At the fifth stage in the window 102 in the left upper part of FIG. 16, a timing is shown at which animations are displayed based on the rules of displaying animations corresponding to the description at row number 5 in the window 103 in the left lower part of FIG. 16. At row number 5 in the window 103 in the left lower part of FIG. 16, it is set forth that an animation with ID=0 and in an animation file corresponding to “a1” is reproduced from the first frame of the animation file at timings from the 34th frame to a point immediately preceding the 46th frame.

At the sixth stage in the window 102 in the left upper part of FIG. 16, a timing is shown at which an animation is displayed based on the rules of displaying animations corresponding to the description at row number 6 in the window 103 in the left lower part of FIG. 16. At row number 6 in the window 103 in the left lower part of FIG. 16, it is set forth that an animation with ID=0 and in an animation file corresponding to “a1” is reproduced from the first frame of the animation file at timings from the 34th frame to a point immediately preceding the 41st frame.

At the seventh stage in the window 102 in the left upper part of FIG. 16, a timing is shown at which an animation is displayed based on the rules of displaying animations corresponding to the description at row number 7 in the window 103 in the left lower part of FIG. 16. At row number 7 in the window 103 in the left lower part of FIG. 16, it is set forth that an animation with ID=1 and in an animation file corresponding to “a2” is reproduced from the first frame of the animation file at the timings from the 42nd frame to a point immediately preceding the 46th frame.

The description in the 38th frame of the top stage in the window 102 in the left upper part of FIG. 16 is based on the rules of processing events corresponding to the description at row number 10 in the window 103 in the left lower part of FIG. 16. At row number 10 in the window 103 in the left lower part of FIG. 16, it is set forth that the processing is stopped provided that control arrives immediately ahead of the 39th frame after entering the 38th frame.

The description at the 43rd frame at the top stage in the window 102 in the left upper part of FIG. 16 is based on the rules of processing events corresponding to the description at row number 11 in the window 103 in the left lower part of FIG. 16. The description at row number 11 in the window 103 in the left lower part of FIG. 16 is that the processing is stopped provided that control arrives immediately ahead of the 44th frame after entering the 43rd frame.

The description in the 48th frame at the top stage in the window 102 in the left upper portion of FIG. 16 is based on the rules of processing events corresponding to the description at row number 12 in the window 103 in the left lower part of FIG. 16. The description at row number 12 in the window 103 in the left lower part of FIG. 16 is that the processing is stopped provided that control arrives immediately ahead of the 49th frame after entering the 48th frame.

The description at the 53rd frame at the top stage in the window 102 in the left upper part of FIG. 16 is based on the rules of processing events corresponding to the description at row number 13 in the window 103 in the left lower part of FIG. 16. The description at row number 13 in the window 103 in the left lower part of FIG. 16 is that the processing is stopped provided that control arrives immediately ahead of the 54th frame after entering the 53rd frame.

The descriptions about the labels L11 to L13 in the window 102 in the left upper part of FIG. 16 correspond to the descriptions at row numbers 17 to 22 in the window 103 in the left lower part of FIG. 16. The descriptions at row numbers 18 to 21 in the window 103 in the left lower part of FIG. 16 are as follows: (i) Label A starts from the second frame; (ii) Label B starts from the 39th frame; (iii) Label C starts from the 44th frame; and (iv) Label D starts from the 54th frame.

Where an edit is performed from the state shown in the left part of FIG. 16 such that 42nd frame, for example, is erased and that the status length of the timeline is shortened, the timeline assumes the state in which all the description in the 42nd frame is deleted from the state shown in the left upper part of FIG. 16 as shown in the central upper part of FIG. 16.

With respect to the rules of displaying animations, the description at row number 3 in the window 103 in the central lower part of FIG. 16 is shorter than the description at row number 3 in the window 103 in the left lower part of FIG. 16 by an amount corresponding to one frame of display timing. A modification is made from the 41st frame to a point immediately preceding the 43rd frame.

The description at row number 5 in the window 103 in the left lower part of FIG. 16 is divided into descriptions at row numbers 5 and 6 in the window 103 in the central lower part of FIG. 16. The display timing is shortened by an amount corresponding to one frame. As a result, the description at row number 5 in the window 301 in the central lower part of FIG. 16 is that an animation with ID=0 in an animation file corresponding to “a1” is reproduced from the first frame of the animation file at timings from the 34th frame to a point immediately preceding the 43rd frame. The description at row number 6 in the window 301 in the central lower part of FIG. 16 is that an animation with ID=0 in an animation file corresponding to “a1” is reproduced from the ninth frame of the animation file at timings from the 44th frame to a point immediately preceding the 47th frame. That is, because the unedited 42nd frame is deleted, the description at row number 5 in the window 103 in the central lower part of FIG. 16 is that an animation file up to a point immediately prior to the deletion is reproduced. The description at row number 6 is that an animation is reproduced from the ninth frame of the animation file that has undergone the deletion. That is, the description is that an animation is reproduced from the offset position.

Similarly, the description at row number 7 in the window 103 of the left lower part of FIG. 16 is divided into descriptions at row numbers 8 and 9 in the window 103 of the central lower part of FIG. 16. The display timing is shortened by an amount corresponding to one frame. As a result, the description at row number 8 in the window 301 in the central lower part of FIG. 16 is that an animation with ID=1 in an animation file corresponding to “a2” is reproduced from the first frame of the animation file at timings from the 42nd frame to a point immediately preceding the 43rd frame. The description at row number 9 in the window 301 in the central lower part of FIG. 16 is that an animation with ID=1 in an animation file corresponding to “a2” is reproduced from the second frame of the animation file at timings from the 44th frame to a point immediately preceding the 46th frame.

Furthermore, the description at row numbers 13 to 17 in the window 103 in the central lower part of FIG. 16 is similar to the description of the rules of processing events except that the frame numbers located after the deleted 42nd frame are each reduced by an amount corresponding to one frame.

At this time, as the 42nd frame is deleted, label information is shifted by an amount corresponding to one frame. That is, the descriptions at row numbers 22 and 23 in the central lower part of FIG. 16 are similar to the descriptions at row numbers 20 and 21 in the left lower part of FIG. 16 except that the frame numbers are reduced by an amount corresponding to one frame.

Conversely, where the intervals from the 39th frame (at the second stage from the above) to a point immediately preceding 44th frame are extended to immediately ahead of the 53rd frame from the state in the left upper part of FIG. 16, an edit is performed as shown in the right upper part of FIG. 16.

Because of this processing, the number of frames in the description at row number 16 in the window 103 in the right lower part of FIG. 16 is increased by an amount corresponding to the extension of the timeline. The resulting rules of processing events are at timings from the 39th frame to a point immediately ahead of the 53rd frame. As a result of this processing, the intervals at the fifth and seventh stages are severed. Therefore, the description of the rules of displaying animations is divided. That is, the description at row number 5 in the window 301 of the left lower part of FIG. 16 becomes descriptions at row numbers 5 and 6 in the window 301 in the right lower part of FIG. 16. The description at row number 5 in the window 301 in the right lower part of FIG. 16 is that an animation with ID=0 in an animation file corresponding to “a1” is reproduced from the first frame of the animation file at timings from the 34th frame to a point immediately preceding the 44th frame forming a starting point from which the interval is extended. The description at row number 6 in the window 301 in the right lower part of FIG. 16 is that an animation with ID=0 in an animation file corresponding to “a1” is reproduced from the first frame of the animation file at timings from the 53rd frame to a point immediately preceding the 55th frame.

Similarly, the description at row number 6 in the window 301 in the left lower part of FIG. 16 become descriptions at row numbers 8 and 9 in the window 301 in the right lower part of FIG. 16. The description at row number 8 in the window 301 in the right lower part of FIG. 16 is that an animation with ID=1 in an animation file corresponding to “a2” is reproduced from the first frame of the animation file at timings from the 42nd frame to a point immediately preceding the 44th frame forming a starting point of extension of interval. The description at row number 9 in the window 301 in the right lower part of FIG. 16 is that an animation with ID=1 in an animation file corresponding to “a2” is reproduced from the first frame of the animation file at timings from the 53rd frame to a point immediately preceding the 55th frame.

The description of the rules of processing events is similar to the description at row numbers 12 to 17 in the window 103 of the right lower part of FIG. 16 except that description corresponding to the 9 slid frames having the frame numbers located after the deleted 44th frame is added.

At this time, description of the 9 slid frames having the frame numbers located after the 44th frame are added to the information about the label information. That is, the description at row numbers 22 and 23 in the right lower part of FIG. 16 is similar to the description at row numbers 20 and 21 in the left lower part of FIG. 16 except that description corresponding to the 9 frames is added.

When the state length is modified, the state transition diagram is not varied. Therefore, the state transition diagram remains unchanged.

Addition or deletion of state transitions is next described.

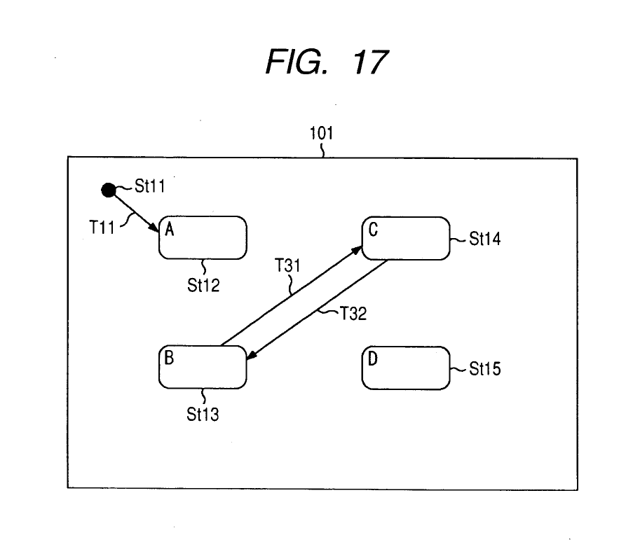

For example, in the case of timelines indicated by windows 102 and 103 of the left part of FIG. 16 and UI configuration data, the state transition diagram is indicated by the window 101 of FIG. 17.

That is, in the window 101 of FIG. 17, state frames St11 to St14 corresponding to states A to D are described. It is set forth that state transition T11 is directed from the state frame St11 forming the start point to state frame St12. It is set forth that state transition T31 is directed from state frame St13 toward state frame St14 (from state B toward state C). It is set forth that state transition T32 is directed from state frame St14 toward state frame St13 (from state C toward state B). The transitions T31 and T32 correspond to the descriptions at row numbers 14 and 15 in the window 103 in the left lower part of FIG. 16.

Accordingly, if the state transitions T31 and T32 are described in a state transition diagram, row numbers 14 and 15 in the window 103 in the left lower part of FIG. 16 are respectively described. At the same time, a description as at the second stage is given in the timeline in the left upper part of FIG. 16. Conversely, if state transitions T31 and T32 are deleted from the state transition diagram, the descriptions at row numbers 14 and 15 in the window 103 in the left lower part of FIG. 16 are deleted. At the same time, the description at the second stage in the timeline in the left upper part of FIG. 16 is deleted. In the timeline, an edit is performed as shown at the second stage in the timeline in the left upper part of FIG. 16. Thus, transitions T31 and T32 are described as shown in FIG. 17 in the state transition diagram. Because the description at the second stage in the timeline in the left upper part of FIG. 16 is deleted, state transitions T31 and T32 as shown in FIG. 17 are deleted from the state transition diagram.

In the embodiment described so far, when UI configuration data is edited, the UI configuration data can be expressed either in a state transition diagram or in a timeline. Therefore, the UI configuration data can be edited in any one of them. The results of edit of the state transition diagram can be reflected in the UI configuration data and in the timeline. Conversely, the results of edit of the timeline can be reflected in the UI configuration data and in the state transition diagram.

Since the UI configuration data can be expressed either by a state transition diagram or by a timeline, interchangeability can be attained between the state transition diagram and the timeline. The timeline can be edited using the state transition diagram. Also, the state transition diagram can be edited using the timeline.

According to one embodiment of the present invention, a timeline is created based on data used in executing a user interface. A state transition diagram is created based on the data. The timeline is edited based on the contents of a manipulation of the timeline. The state transition diagram is edited based on the contents of the manipulation of the state transition diagram. The data is edited and updated based on the results of the edit of the timeline or on the results of the edit of the state transition diagram. Consequently, the efficiency of development of UI programs can be improved. In addition, timeline and state transition diagram which are based on the same UI program can be converted into each other.

The above-described sequence of process operations can be executed by hardware or software. Where the sequence of process operations is executed by software, a program constituting the software is installed from a program recording medium into a computer built in dedicated hardware or into a general-purpose personal computer or the like that can implement various functions by installing various programs.

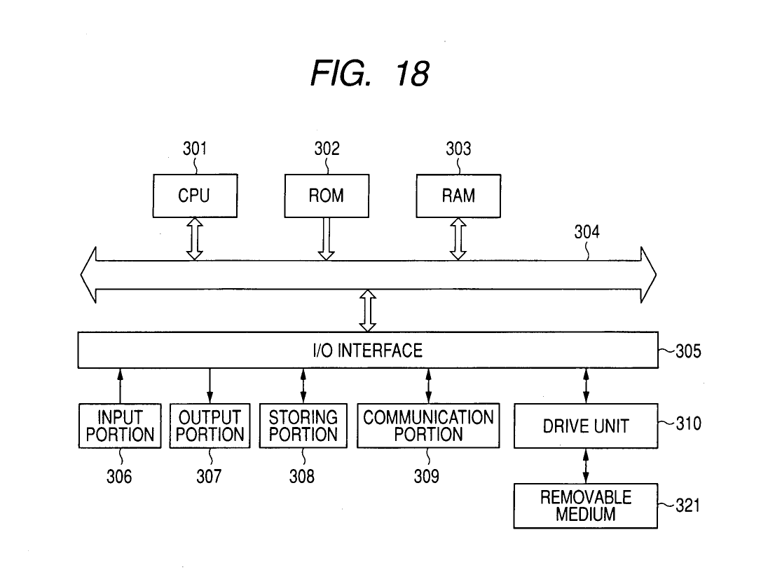

FIG. 18 shows the configuration of one example of a personal computer used in a case where the electrical internal configuration of the editing device 1 of FIG. 1 is realized by software. The personal computer has a CPU 301 that controls the operation of the whole personal computer. When an instruction is entered by a user from an input portion 306 including a keyboard and a mouse into the CPU 301 via a bus 304 and via an input/output (I/O) interface 305, the CPU executes a program loaded in a ROM (read only memory) 302 in a corresponding manner. Alternatively, the CPU 301 loads a program into a RAM (random access memory) 303 and executes the program, the program being installed in a storage portion 308 after being read from a removable medium 321 connected with a drive unit 310. The removable medium includes a magnetic disc, optical disc, magnetooptical disc, or semiconductor memory. Thus, the functions of the editing device 1 of FIG. 1 are implemented in software. The CPU 301 controls a communication portion 309 and makes communications with the outside, thus performing reception and transmission of data.

The program recording medium in which a program that is installed in the computer and is made executable by the computer is made of a magnetic disc (including a flexible disc), an optical disc (including a CD-ROM (Compact Disc-Read Only Memory), DVD (Digital Versatile Disc), or magnetooptical disc), the removable medium 321 that is a packaged medium made, for example, of a semiconductor memory, the ROM 302 in which the program is temporarily or permanently stored, or a hard disc forming the storage portion 308. A program is loaded into the program recording medium via the communication portion 309 that is an interface such as a router, modem, or the like as the need arises by making use of a cabled or wireless communication medium such as a local area network, the Internet, or digital satellite broadcast.

In the present specification, the process steps describing the program loaded in the program recording medium, of course, include processing steps carried out in the order already described, i.e., in a time sequential order. The steps may not be carried out in a time sequential order. The steps may also be carried out in parallel or separately.

The embodiments of the present invention are not limited to the above-described embodiments. Various changes and modifications are possible without departing from the gist of the present invention.

It should be understood by those skilled in the art that various modifications, combinations, sub-combinations and alterations may be occur depending on design requirements and other factors insofar as they are within the scope of the appended claims or the equivalents thereof.

What is claimed is:

1. A method of processing information, comprising the steps of:
creating a timeline based on data used in executing a user interface;
creating a state transition diagram based on the data;
manipulating the timeline or the state transition diagram;
editing the timeline based on contents of the manipulation of the timeline performed in the manipulating step;
editing the state transition diagram based on contents of the manipulation of the state transition diagram performed in the manipulating step; and
editing and updating the data based on results of the edit of the timeline performed by processing performed in the step of editing the timeline or on results of the edit of the state transition diagram performed by processing performed in the step of editing the state transition diagram.

2. A method of processing information as set forth in claim 1, wherein the data includes rules of displaying animations, rules of processing events, and information about labels.

3. A method of processing information as set forth in claim 2, wherein the step of editing and updating the data adds a new label of the same structure as the labels to information about the labels contained in the data and edits and updates the information when a factor producing a state has occurred provided that processing in the step of editing the timeline edits the timeline to thereby change the corresponding rules of processing events or provided that processing in the step of editing the state transition diagram edits the state transition diagram changes the corresponding rules of processing events.

4. A method of processing information asset forth in claim 3, further including the steps of:
editing and updating the rules of processing events in the data in a case where editing processing performed in the step of editing the timeline changes the corresponding rules of processing events or in a case where editing processing performed in the step of editing the state transition diagram changes the corresponding rules of processing events;
newly creating information about the labels when the factor producing a state has occurred provided that processing performed in the step of setting the rules of processing events edits and updates the rules of processing events; and
editing and updating the rules of displaying animations contained in the data provided that editing processing performed in the step of editing the timeline changes the corresponding rules of displaying animations or that editing processing performed in the step of editing the state transition diagram changes the corresponding rules of displaying animations;
wherein processing performed in the step of editing the data is to edit and update the data based on the rules of processing events created by processing performed in the step of setting rules of processing events, label information created by processing performed in the step of newly creating information about the labels, and the rules of displaying animations created by processing performed in the step of setting rules of displaying animations.

5. An information processor comprising:
means for creating a timeline based on data used in executing a user interface;
means for creating a state transition diagram based on the data;
manipulation means for manipulating the timeline or the state transition diagram;
timeline edition means for editing the timeline based on contents of the manipulation of the timeline performed by manipulation of the manipulation means;
state transition diagram edition means for editing the state transition diagram based on contents of the manipulation of the state transition diagram performed by the manipulation of the manipulation means; and
means for editing and updating the data based on results of edit of the timeline performed by the timeline edition means or on results of edit of the state transition diagram performed by the state transition diagram edition means.

6. A recording medium recorded with a computer-readable program which causes a computer to implement a method comprising the steps of:
creating a timeline based on data used in executing a user interface;
creating a state transition diagram based on the data;
manipulating the timeline or the state transition diagram;
editing the timeline based on contents of the manipulation of the timeline performed in the manipulating step;
editing the state transition diagram based on contents of the manipulation of the state transition diagram performed in the manipulating step; and
editing and updating the data based on results of the edit of the timeline performed in the step of editing the timeline or on results of the edit of the state transition diagram performed in the step of editing the state transition diagram.

7. A program for causing a computer to implement processing including the steps of:
creating a timeline based on data used in executing a user interface;
creating a state transition diagram based on the data;
manipulating the timeline or the state transition diagram;
editing the timeline based on contents of the manipulation of the timeline performed in the manipulating step;
editing the state transition diagram based on contents of the manipulation of the state transition diagram performed in the manipulating step; and
editing and updating the data based on results of the edit of the timeline performed in the step of editing the timeline or on results of the edit of the state transition diagram performed in the step of editing the state transition diagram.

8. An information processor comprising:
a device for creating a timeline based on data used in executing a user interface;
a device for creating a state transition diagram based on the data;
a manipulation device for manipulating the timeline or the state transition diagram;
a timeline edition device for editing the timeline based on contents of the manipulation of the timeline performed by manipulation of the manipulation means;
a state transition diagram edition device for editing the state transition diagram based on contents of the manipulation of the state transition diagram performed by the manipulation of the manipulation means; and
a device for editing and updating the data based on results of edit of the timeline performed by the timeline edition means or on results of edit of the state transition diagram performed by the state transition diagram.
